(19) United States
(12) Patent Application Publication
(10) Pub. No.: US 2024/0403882 A1
(43) Pub. Date: Dec. 5, 2024

(54) TRANSACTIONAL BIOMETRIC ENROLLMENT

(71) Applicant: IDEX BIOMETRICS ASA, Oslo (NO)

(72) Inventors: Anthony Michael EATON, Hampshire (GB); Keith AHLUWALIA, Wiltshire (GB); Peter Eckehard KOLLIG, Hampshire (GB); Hassan RAFIQUE, Lalazar, Rawalpindi (PK)

(21) Appl. No.: 18/695,120

(22) PCT Filed: Nov. 18, 2022
(86) PCT No.: PCT/EP2022/082497

§ 371 Date: Mar. 25, 2024

Related U.S. Application Data
(60) Provisional application No. 63/281,217, filed on Nov. 19, 2021.

(51) Int. Cl. G06Q 20/40; G06Q 20/20; G06Q 20/32; G06Q 20/34; G07F 7/10

(52) U.S. Cl. CPC G06Q 20/40145; G06Q 20/20; G06Q 20/3278; G06Q 20/341; G07F 7/1025

(57) ABSTRACT

A method for generating a trusted biometric reference includes initiating a first contactless transaction, capturing a first biometric sample during the first contactless transaction, generating a first biometric probe from the first biometric sample, initiating a contact fallback event, entering a secondary identifier, if the secondary identifier confirms an authorized user, generating a first trusted biometric reference from the first biometric probe, and storing the first trusted biometric reference in a biometric template seed.

### BACKGROUND

Remote biometric user authentication is becoming more and more ubiquitous as a way of verifying a user's identity and securely requesting the authorization of transactions initiated by that user. Biometric authentication for example, fingerprint matching, can be performed using an electronic device in the user's possession e.g., a smart card. In this example, a user's identity may be verified by comparing a fingerprint sample provided by the user to a trusted biometric template of that user. A trusted biometric template may be created by, for example, obtaining and storing one or more trusted samples of a user's fingerprint (or portions of a fingerprint) in a trusted template. Subsequent fingerprint samples are compared against the trusted template to authenticate the user. The trusted template may also be referred to as a trusted biometric template or a verification template. The trusted template may be developed during an enrollment process, whereby a user's biometric sample or samples are obtained. In some embodiments, a trusted template may be referred to as an enrolled template. A conventional enrollment process may take place prior to use of a smart card. However, it may be desirable to allow enrollment to occur during use, or limited use, of a smart card.

### SUMMARY

In an exemplary embodiment, a method for generating a trusted biometric reference includes initiating a first contactless transaction, capturing a first biometric sample during the first contactless transaction, generating a first biometric probe from the first biometric sample, initiating a contact fallback event, entering a secondary identifier, if the secondary identifier confirms an authorized user, generating a first trusted biometric reference from the first biometric probe, and storing the first trusted biometric reference in a biometric template seed.

In another exemplary embodiment, a method for transactional biometric enrollment includes building a biometric template seed comprising a plurality of trusted biometric references, initiating a first contactless transaction, capturing a first biometric sample during the first contactless transaction, determining a biometric enrollment status of a user, if the enrollment status is active, determining if a biometric template seed is complete, if the biometric template seed is complete, generating a first biometric probe from the first biometric sample, comparing the first biometric probe to the biometric template seed and if the first biometric probe matches the biometric template seed, generating a first verified biometric reference from the first biometric probe and expanding a first biometric template with the first verified biometric reference.

In another exemplary embodiment, a method for transactional biometric enrollment includes initiating a first contactless transaction, capturing a first biometric sample during the first contactless transaction, determining a biometric enrollment status of a user, if the enrollment status is active, generating a first biometric probe from the first biometric sample and storing the first biometric probe as a biometric reference in a first biometric template, capturing a first subsequent biometric sample during a first subsequent contactless transaction, determining the biometric enrollment status of the user, if the enrollment status is active, generating a first subsequent biometric probe from the first subsequent biometric sample, and comparing the first subsequent biometric probe to the first biometric template and if the first subsequent biometric probe does not match the first biometric template, generating a second biometric template in which to store the first subsequent biometric probe as a first unverified biometric reference.

In another exemplary embodiment, a method for transactional biometric enrollment includes initiating a first contactless transaction, capturing a first biometric sample during the first contactless transaction, generating a first biometric probe from the first biometric sample, determining a biometric enrollment status of a user, if the enrollment status is active, determining whether on-line trust establishment is desired, if on-line trust establishment is desired, communicating a request to a user device, and in response to affirmation of the request, saving the first biometric probe as a trusted biometric reference in a biometric template.

In another exemplary embodiment, a system for generating a trusted biometric reference includes a biometric sensor configured to capture a first biometric sample during a first contactless transaction, a processor and biometric processing logic configured to generate a first biometric probe from the first biometric sample, a secondary identifier entered during a contact fallback event, if the secondary identifier confirms an authorized user, the processor and biometric processing logic configured to generate a first trusted biometric reference from the first biometric probe, and a memory configured to store the first trusted biometric reference in a biometric template seed.

In another exemplary embodiment, a system for transactional biometric enrollment includes a biometric template seed comprising a plurality of trusted biometric references, a biometric sensor configured to capture a first biometric sample during a first contactless transaction, a biometric processing logic configured to determine a biometric enrollment status of a user, if the enrollment status is active, the biometric processing logic configured to determine if a biometric template seed is complete, if the biometric template seed is complete, a processor and the biometric processing logic configured to generate a first biometric probe from the first biometric sample, and a matcher configured to compare the first biometric probe to the biometric template seed and if the first biometric probe matches the biometric template seed, the processor and biometric processing logic configured to generate a first verified biometric reference from the first biometric probe and a memory configured to store the first verified biometric reference in a first biometric template.

In another exemplary embodiment, a system for transactional biometric enrollment includes a biometric sensor configured to capture a first biometric sample during a first contactless transaction, a biometric processing logic configured to determine a biometric enrollment status of a user, if the enrollment status is active, a processor and the biometric processing logic configured to generate a first biometric probe from the first biometric sample, a memory configured to store the first biometric probe as a biometric reference in a first biometric template, the biometric sensor configured to capture a first subsequent biometric sample during a first subsequent contactless transaction, a biometric processing logic configured to determine a biometric enrollment status of a user, if the enrollment status is active, the processor and the biometric processing logic configured to generate a first subsequent biometric probe from the first subsequent biometric sample, and a matcher configured to compare the first subsequent biometric probe to the first biometric template and if the first subsequent biometric probe does not match the first biometric template, the processor and biometric processing logic configured to generate a second biometric template in which to store the first subsequent biometric probe as an unverified biometric reference.

In another exemplary embodiment, a system for transactional biometric enrollment includes a biometric sensor configured to capture a first biometric sample during the first contactless transaction, a processor and biometric processing logic configured to generate a first biometric probe from the first biometric sample, the biometric processing logic configured to determine a biometric enrollment status of a user, if the enrollment status is active, a biometric management module and a trust establishment module configured to determine whether on-line trust establishment is desired, if on-line trust establishment is desired, a digital banking system configured to communicate a request to a user device, and in response to affirmation of the request, saving the first biometric probe as a trusted biometric reference in a biometric template.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

Exemplary embodiments can be better understood with reference to the following drawing(s). The components in the drawing(s) is/are not necessarily to scale, emphasis instead being placed upon clearly illustrating the principles of the present invention.

FIG. 1 illustrates a biometric sensor assembly or a biometric sensor, such as fingerprint sensor, instantiated on a smart card according to some embodiments.

FIG. 2 is a block diagram of a portion of the smart card of FIG. 1.

FIG. 3A is a block diagram showing a biometric template used with verified transactional biometric enrollment using a trusted template seed.

FIG. 3B is a block diagram showing a biometric template used with verified transactional biometric enrollment.

FIG. 4 is a diagram showing an exemplary embodiment of transactional biometric enrollment with on-card trust establishment.

FIG. 5 is a flow chart showing an exemplary embodiment of a method for transactional biometric enrollment with on-card trust establishment.

FIG. 6 is a diagram showing an exemplary embodiment of verified transactional biometric enrollment using a trusted template seed.

FIG. 7 is a flow chart showing an exemplary embodiment of a method for verified transactional biometric enrollment using a trusted template seed.

FIG. 8A is a diagram showing an exemplary embodiment of verified transactional biometric enrollment.

FIG. 8B is a diagram showing another exemplary embodiment of verified transactional biometric enrollment.

FIG. 9 is a flow chart showing a method for an exemplary embodiment of verified transactional biometric enrollment.

FIG. 10 is a diagram showing an exemplary embodiment of verified transactional biometric enrollment.

FIGS. 11A and 11B collectively are a flow chart showing a method for an exemplary embodiment of on-line verified transactional biometric enrollment with interactivity.

FIGS. 12A and 12B collectively are a flow chart showing a method for an exemplary embodiment of on-line verified transactional biometric enrollment without interactivity.

### DETAILED DESCRIPTION

While aspects of the subject matter of the present application may be embodied in a variety of forms, the following description and accompanying drawings are merely intended to disclose some of these forms as specific examples of the subject matter. Accordingly, the subject matter of this application is not intended to be limited to the forms or embodiments so described and illustrated.

Unless defined otherwise, all terms of art, notations and other technical terms or terminology used herein have the same meaning as is commonly understood by one of ordinary skill in the art to which this application belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

This description may use relative spatial and/or orientation terms in describing the position and/or orientation of a component, apparatus, location, feature, or a portion thereof. Unless specifically stated, or otherwise dictated by the context of the description, such terms, including, without limitation, top, bottom, above, below, under, on top of, upper, lower, left of, right of, in front of, behind, next to, adjacent, between, horizontal, vertical, diagonal, longitudinal, transverse, radial, axial, etc., are used for convenience in referring to such component, apparatus, location, feature, or a portion thereof in the drawings and are not intended to be limiting.

Furthermore, unless otherwise stated, any specific dimensions mentioned in this description are merely representative of an exemplary implementation of a device embodying aspects of the application and are not intended to be limiting.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as well as instances in which the event, circumstance, characteristic, or property occurs to a close approximation, such as accounting for typical tolerance levels or variability of the embodiments described herein.

As used herein, the terms “optional” and “optionally” mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

### Biometric Identity Authentication or Verification

There are currently a number of ways to verify that a person is who they claim to be; for example, comparing a feature that is unique to a person to a pre-existing version of that feature that may be subject to counterfeit. For example, matching a newly generated handwriting signature to a handwriting signature on file is one traditional way of verifying a person's identity, but it is subject to forgery. As another example, matching a person's face to a photograph on their official identification card is another well accepted form of biometric identity authentication. These matching techniques (identity verification and authentication techniques) are useful, but these tests can be circumvented.

A user's fingerprint is a unique biometric identifier (or feature) of that user. For example, fingerprints have been used by law enforcement and immigration authorities for some time, but the expense of collecting, archiving and matching fingerprints have traditionally been costly and impractical. Digital technologies have simplified the capture of an image of a fingerprint. For example, an image of a fingerprint can be captured, encoded and stored electronically so that key identification features of the user can be associated with this particular fingerprint image. Then a new fingerprint (image, sample) can be captured, and compared with the previously stored fingerprint image and a statistical estimate can be made corresponding to the likelihood that the new fingerprint is a sufficient match with the previously collected fingerprint sample(s).

A fingerprint is one of many modalities that may be useful for biometric authentication. Other biometric modalities exist, such as two dimensional (2D) and three dimensional (3D) facial recognition, palm recognition, iris recognition, gait recognition, voice recognition, etc. Different biometric modalities offer different experiences for the user and different metrics for confidence of a match. However, attempting to maintain the biometric identifier or feature as confidential is not practical.

### Biometric Smart Card

A modern smart card may incorporate a biometric sensor capable of obtaining, processing, analyzing, and storing a biometric sample. A biometric sensor, and processing circuitry on a modern smart card may be configured to operate on power provided to the smart card by an external power source, or by a power source on the smart card. For example, a contact-enabled smart card may obtain power from a reader terminal, an enrollment sleeve, or another power source. A non-contact enabled smart card may obtain power from a reader terminal, a smart phone, or another power source using, for example, near field communication (NFC) or other wireless technology.

A device without a graphic display such as a biometrically enabled smart card presents a much greater challenge to creating a comprehensive trusted template than devices with display capability such as smartphones. Such a card could be electronically or wirelessly connected to a host device with a native display to perform an equivalent interactive enroll process. The drawback is that this is often a complicated process that is user unfriendly. Transactional enrollment removes the requirement for a user guided enrollment making enrollment part of the initial typical use of the smart card.

It is common to see biometric sensors, such as, for example, fingerprint sensors, or other biometric sensors configured to capture one or more of image data, audio data, ultrasonic data, electric field data, and other data installed on human interface devices such as smartphones, laptops, tablets, or other devices. For example, a fingerprint sensor installed on a smart phone can be used to verify the identity of the user. The fingerprint sensor can also be used as a data entry or a control mechanism for the smart phone. For example, the fingerprint sensor can detect the presence of a single finger touch and be programmed to activate a smart phone function or application upon detection.

As fingerprint sensors gain in implementation and user acceptance, fingerprint sensors are now finding use in numerous other devices such as, for example, smart cards, fitness monitors or trackers, wearable devices, domestic and industrial appliances, automotive components, and internet of things (IOT) devices. Some devices, such as smart cards and IOT devices, have limited or no user interfaces or status indicators such as screens, speakers, light emitting diodes (LEDs), or audio signals with which the device may impart information to the user. Such devices may also have limited or no user input mechanisms for receiving user input due to lack of a keyboard, switches, buttons, or levers.

While described herein in the context of a biometric smart card, the systems, methods, devices, and uses described herein may be implemented on other form factors, such as, for example only, a dongle, a wearable device, or other form factors.

In order for a biometric sensor, such as, for example, a fingerprint sensor, to function as a user verification device, a sufficiently detailed template (or multiple templates) of a user's biometric data (e.g., fingerprint) must be captured and stored during an enrollment process. The stored template (i.e., a trusted template, a trusted biometric template, or a verification template, of biometric data (e.g., a fingerprint image)) is used to compare with biometric image data generated by the biometric sensor (e.g., an image of a finger, or one or more portions of a finger, sensed by the fingerprint sensor, sometimes referred to as a “live sensed image”, a “live fingerprint sample”, a “live image sample” or a “live image”) when the device is in subsequent general use, as known to those having ordinary skill in the art.

While concepts described herein are applicable to various biometric sensors and associated biometric data and verification templates of biometric data, for purposes of illustration, and not for limitation, examples are frequently described herein in the context of fingerprint sensors and fingerprint data (i.e., images).

In the context of the present application, a “sensor element” comprises an arrangement of one or more components configured to produce a signal based on a measurable parameter (e.g., capacitance, light/optics, heat/thermal, pressure, etc.), characteristics of which will vary based on the presence or absence of an object that is in local proximity to the sensor element. For example, a capacitive fingerprint sensor will comprise an array of such sensor elements configured to produce an electrical signal proportional to the impedance of the surface of a finger placed on or near the fingerprint sensor. The sensitivity of each of the sensor elements of the fingerprint sensor is such that characteristics of the signal produced at each sensor element will vary based on surface characteristics, such as ridge patterns of the portion of a finger placed on or near the array, and the varying characteristics of signals produced at each sensor element may be combined or otherwise processed to form a data file that is a biometric representation of the finger surface placed on or near the array. Specific examples of such sensor elements may include, but are not restricted to, capacitive, ultrasonic, optical, thermal, and pressure sensor elements.

In addition, sensor elements contemplated herein include both silicon-based sensors in which sensor elements are formed directly on a silicon semiconductor substrate and may form a 2-dimensional array of sensing pixels and off-silicon sensors in which sensor elements are not disposed directly on a silicon semiconductor substrate (e.g., so-called off-chip sensors) but formed on a non-silicon substrate and are conductively connected to a remotely-located control element, which may be a silicon-based semiconductor chip, such as an application specific integrated circuit (ASIC).

While aspects of this application are presented in the context of specific types of sensor elements and fingerprint sensor configurations, it should be appreciated that implementations of those aspects are not necessarily limited to a specific type of sensor element of the fingerprint sensors described herein.

### Definitions

### Biometric Identifier:

A unique feature of an individual (or user), such as a fingerprint.

### Biometric Sample:

A single capture of an individual's biometric characteristics. A biometric sample can represent a range of different biometric characteristics, but as used herein generally refers to an image representing a portion of a fingerprint.

### Biometric Probe:

The biometric features extracted from a single biometric sample, to be submitted for comparison against a biometric template as part of the biometric verification process.

### Trusted Biometric Probe:

A biometric probe that has been established to originate from a biometric sample of an authorized user, or an intended enrollee.

### Biometric Claim:

As used herein, the term “biometric claim” refers to an application for biometric verification. A biometric claim that an individual biometric sample comes from the same biometric source as the biometric references. A biometric claim can be positive (the individual from which the biometric sample was captured is enrolled); or negative (the individual from which the biometric sample was captured is not enrolled).

### Biometric Verification:

As used herein, the term “biometric verification” refers to the process of confirming a biometric claim through a comparison (or “matching”) process. The comparison process assesses the similarity of a biometric probe with the biometric reference data held within the biometric template.

### Biometric Reference (or Biometric Reference Data):

The biometric features or data extracted, during biometric enrollment, from a single biometric sample, to be stored as part of a biometric template.

### Biometric Enrollment:

The process of collecting and storing biometric reference data to be used in the comparison process associated with biometric verification.

### Biometric Feature Extraction:

The process applied to a captured biometric sample to extract biometric features to form a biometric probe that allows a comparison process to be performed during biometric verification.

### Trusted Biometric Reference:

Biometric reference data that has been established to originate from an authorized user, or the intended enrollee.

### Untrusted Biometric Reference:

Biometric reference data that has not been established to originate from an authorized user, or the intended enrollee.

### Verified Biometric Reference:

A biometric sample becomes a verified biometric reference upon successful verification against one of the unverified or verified biometric references in a template. Verified biometric references are added to the verified reference area of a biometric template.

### Unverified Biometric Reference:

Biometric reference data that has not been verified against other biometric references in a template. It is generally the first biometric reference in a new template. Unverified biometric references are added to the unverified reference area of a biometric template.

### Unverified Reference Area:

A location in a biometric template for storing unverified biometric references.

### Verified Reference Area:

A location in a biometric template for storing verified biometric references.

### Trusted Seed Area:

A location in a biometric template for storing trusted biometric seeds.

### Enrollment Index:

A pointer into the biometric template area, indicating where the next biometric reference is to be stored.

### Trust Establishment Policy:

A configuration value that determines whether a form of trust establishment is needed prior to starting a new template area.

### Biometric Template:

A collection of stored biometric references that will be directly compared to a biometric probe during the process of biometric verification.

### Transactional Enrollment:

As used herein, the terms “transactional enrollment” and “transactional biometric enrollment” refer to collecting and storing biometric reference data on a smart card or other device while performing the standard transactions that the card or device is intended for. In the context of a payment application, transactional biometric enrollment may also be referred to as point of sale (POS) enroll, “enroll as you pay” or “enroll as you shop”.

### Unverified Transactional Enrollment:

A simplified form of transactional enrollment whereby biometric samples are captured during transactions without comparison to any current biometric reference data. During each transaction these biometric samples are extracted and directly included in the biometric template without any comparison to the current biometric reference data within the biometric template.

### Verified Transactional Enrollment:

A simplified form of transactional enrollment whereby biometric samples are captured during transactions and qualified against current biometric reference sample before inclusion into the biometric template. During each transaction these samples are extracted to initially form a biometric probe and be verified, through a comparison process, against the current biometric reference data within the biometric template. If a successful match is yielded from the comparison process the biometric probe can be considered for inclusion within the biometric template (this process is also known as biometric reference adaptation or biometric template expansion).

### Biometric Template Seed:

One or more biometric references that are captured prior to running a verified transactional enrollment process. Biometric template seeds are typically captured in the same way that biometric reference data is captured during unverified transactional enrollment. When the verified transactional enrollment process starts these seeds form the initial biometric template which is subsequently adapted and enhanced through this process.

### Trust Establishment:

A process to determine, or assess the likelihood, that the biometric reference data collected during transactional biometric enrollment is originating from the intended enrollee, rather than an imposter or unintended user.

### Trust Event:

An event which requires that trust of a biometric reference or references to be established. The entry of a personal identification number (PIN) during a transaction may be a trust event that establishes trust in a biometric probe and the creation of a trusted biometric reference.

### On-card Trust Establishment:

A trust establishment process that is executed on the smart card. As used herein, the term “on-card trust establishment” refers to one or more processes or algorithms that execute on the smart card that can promote a biometric reference to a trusted biometric reference.

### On-line Trust Establishment:

A trust establishment process that is executed as part of the on-line transaction processing. As used herein, the term “on-line trust establishment” refers to on-line processing and analytics of card transaction data to establish trust in the enrollment process.

### Interactive Trust Establishment:

A trust establishment process that requires specific interaction with the cardholder to establish trust in the enrollment process.

### Authentication:

As used herein, the terms “authentication” and “identity authentication” refer to the function of confirming the identity of a user requesting the initiation of a transaction. Identity authentication generally refers to verifying in real time that a user is who they claim to be for the purposes of initiating a transaction and generating a signal corresponding with matching a presented biometric to a reference.

### Validation:

As used herein, the term “validation” refers to offering proof during a transaction request that a biometric authentication was successful.

### PIN Fallback:

An event that occurs during card use where biometric authentication is insufficient and the system seeks a PIN from the user to continue the transaction.

In an exemplary embodiment, one or more systems, methods, devices, and one or more uses of devices for transactional biometric enrollment are disclosed. Embodiments for transactional biometric enrollment described herein may include a way to build a biometric template while allowing use, or limited use of a smart card without compromising security.

Exemplary embodiments for transactional biometric enrollment described herein allow a user to securely enroll their biometric information into a smart card, or other biometric-capable device, and build one or more biometric templates securely and significantly faster and with higher quality than previous methods, while using the smart card for transactions.

Exemplary embodiments for transactional biometric enrollment may also be referred to as “enroll as you pay” or “enroll as you shop”.

Exemplary embodiments for transactional biometric enrollment may be used to reduce the effort that a user must expend to enroll a biometric smart card and thereby improve the user experience.

Exemplary embodiments for transactional biometric enrollment may allow limited value transactions until full enrollments may be completed.

Exemplary embodiments for transactional biometric enrollment may allow limited value transactions to occur in some cases using a personal identification number (PIN) as part of initial transactions or for fallback transactional use.

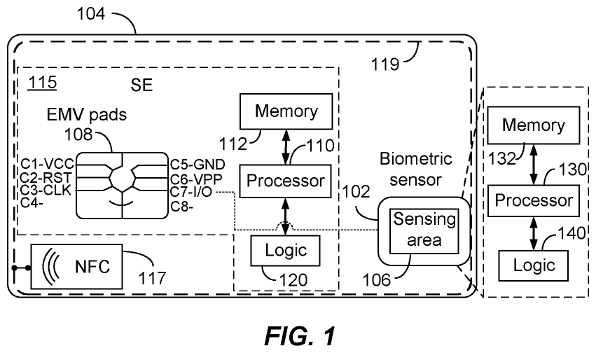

FIG. 1 illustrates a biometric sensor assembly or a biometric sensor, such as biometric sensor 102, installed on a user device. In an exemplary embodiment, the user device may be a smart card 104 according to some embodiments and the biometric sensor 102 may be a fingerprint sensor. In other embodiments, a user device may be a device other than a smart card, such as, for example, a wearable device, a communication device, a personal computing device, a tablet, or another user device. In the illustrated embodiment shown in FIG. 1, the smart card 104 is a limited device, as described above, and the smart card 104 comprises the biometric sensor 102. In some embodiments, the smart card 104 comprises a fingerprint, or other biometric sensor 102, processor or processing circuitry 110, memory 112, logic 120 and contact pads 108 providing contacts for an external power source. In an exemplary embodiment, the biometric sensor 102 may also comprise processor or processing circuitry 130, memory 132 and logic 140. The contact pads 108 may be any type of input/output (I/O) interface, and as an example, may be referred to as EMV (Europay, MasterCard, Visa) pads and may be used to provide a physical connection to a POS terminal, or other host device. The processing circuitry 110 and 130 may be a microprocessor, microcontroller, microcontroller unit (MCU), application-specific integrated circuit (ASIC), field-programmable gate array (FPGA), or any combination of components configured to perform and/or control the functions of the smart card 104. The memory 112 and 132 may be a read-only memory (ROM) or a reprogrammable memory such as EPROM or EEPROM, flash, or any other storage component capable of storing executory programs and information for use by the processing circuitry 110 and 130. The memory 112 and 132 may be volatile or non-volatile. The biometric sensor 102 may comprise sensor controlling circuitry and a sensor memory. The sensor controlling circuitry may be a microprocessor, microcontroller, application-specific integrated circuit (ASIC), field-programmable gate array (FPGA), or any combination of components configured to perform and/or control the functions of the biometric sensor 102. The sensor memory may be a read-only memory (ROM) or a reprogrammable memory such as EPROM or EEPROM, flash, or any other storage component capable of storing executory programs and information for use by the processing circuitry 110 and 130. The sensor controlling circuitry is configured to execute fingerprint sensor application programming (i.e., firmware) stored in the sensor memory. The memory 112 and the sensor memory 132 may be the same component. The sensor controlling circuitry is coupled to or may be part of the processing circuitry 110 and 130. The various components of the smart card 104 are appropriately coupled and the components may be used separately or in combination to perform the embodiments disclosed herein.

In an exemplary embodiment, the memory 112 may comprise logic 120 and the memory 132 may comprise logic 140. The logic 120 and 140 may comprise software, firmware, instructions, circuitry, or other devices, configured to be executed by the processing circuitry 110 and 130, respectively, to control one or more functions of the smart card 104, as described herein.

In an exemplary embodiment, the biometric sensor 102, the processor 110 and/or 130, the memory 112 and/or 132, and the logic 120 and/or the logic 140 may be configured to capture one or more submitted current biometric features corresponding to a biometric sample that may comprise one or more biometric features that form a current user identity sample provided by a user, compare the one or more current biometric sample(s) to a previously obtained biometric sample corresponding to a previously obtained user identity sample, and if the one or more current biometric features in the biometric sample match the previously obtained biometric sample, generate an authorization signal that identifies the current user identity sample as belonging to an authorized user, the authorization signal corresponding to a user initiated successful biometric user authentication.

In an exemplary embodiment, the user specific information that was previously captured and non-volatilely stored on the smart card 104 by an authorized user during a card initialization and user enrollment process comprises at least one biometric identifier of the authorized user.

The contact pads 108 comprise one or more power transmission contacts, which may connect electrical components of the smart card 104, such as an LED, the processing circuitry 110, memory 112, sensor elements (e.g., the biometric sensor 102) etc., to an external power source. In some embodiments, the contact pads 108 further comprise one or more data transmission contacts that are distinct from the power transmission contacts which connect the smart card 104 to an external device configured to receive data from and/or transmit data to the smart card 104. In this context, the data transmission contacts of the smart card 104 are the contacts that convey data transmitted to or transmitted from the smart card 104.

The processing circuitry 110, the memory 112 and the logic 120 may comprise a secure element 115. The contact pads 108 may be part of the secure element 115 which includes the processing circuitry 110, memory 112, and logic 120, all of which are in electrical communication with the contact pads 108. In an exemplary embodiment, the secure element 115 may conform to an EMVCo. power management protocol commonly used on smart cards, and the contact pads 108 provide electric contacts between the smart card 104 and a host device, such as for example, a smart phone, an enrollment sleeve, a tablet computer, an external card reader, or other host device, to provide power to the processing circuitry 110 of the card and to read data from and/or write data to the memory 112. In an exemplary embodiment, a host device may provide temporary power to the smart card 104 using, for example, NFC technology, Qi power technology, a combination of NFC and Qi power technology, in which case the smart card 104 includes NFC element 117 or another power element (not shown). In an exemplary embodiment, an antenna 119 may be coupled to the NFC element 117 to allow the smart card 104 to harvest NFC power from a host device, such as an NFT terminal, a POS terminal, a smart phone, a tablet, or another device. Although shown as generally occupying a periphery of the smart card 104, the antenna 119 may take other shapes and configurations. The antenna 119 may comprise metal, or metallic material, and may comprise one or more loops, or may have a meandering configuration.

In some embodiments, NFC capability may be implemented on the smart card 104 using NFC communication element 117 to communicate with a host device, and in some embodiments to allow a host device to provide power, or temporary power, to the smart card 104. NFC is a standards-based wireless communication technology that allows data to be exchanged between devices that are a few centimeters apart. NFC operates at 13.56 MHz and transfers data at up to 424 Kbits/seconds. In some embodiment, the NFC element 117 may be completely or partially part of, or contained within, the secure element 115.

When used for contactless transactions, NFC-enabled smart phones incorporate smart chips (called secure elements, similar to the secure element 115 on the smart card 104) that allow the smart phone to securely store and use the transaction application and consumer account information. Contactless transactions between an NFC-enabled mobile phone and a POS terminal use the standard ISO/IEC 14443 communication protocol currently used by EMV contactless credit and debit chip cards. NFC-enabled smart phones and other devices can also be used for a wide variety of other applications including chip-enabled mobile marketing (e.g., coupons, loyalty programs and other marketing offers), identity and access, ticketing and gaming. NFC is available as standard functionality in many mobile phones and allows consumers to perform safe contactless transactions, access digital content, and connect electronic devices simply. An NFC chip in a mobile device can act as a card or a reader or both, enabling consumer devices to share information and to make secure payments quickly.

In FIG. 1, contact pads 108 embody an exemplary smart card contact arrangement, known as a pinout. In an exemplary embodiment, contact C1, VCC, connects to a power supply. contact C2, RST, connects to a device to receive a reset signal, used to reset the card's communications. Contact C3, CLK, connects to a device to receive a clock signal, from which data communications timing is derived. Contact C5, GND, connects to a ground (reference voltage). In various embodiments, contact C6, VPP, may, according to ISO/IEC 7816-3:1997, be designated as a programming voltage, such as an input for a higher voltage to program persistent memory (e.g., EEPROM). In other embodiments, contact C6, VPP, may, according to ISO/IEC 7816-3:2006, be designated as SPU, for either standard or proprietary use, as input and/or output. Contact C7, I/O, provides Serial input and output (half-duplex). Contacts C4 and C8, the two remaining contacts, are AUX1 and AUX2 respectively and used for USB interfaces and other uses. In an exemplary embodiment, the biometric sensor 102 may communicate with the SE 115 using serial input and output capabilities of the SE 115. In some embodiments the biometric sensor 102 may be directly connected to contact C7.

In some embodiments described herein, the contact pads 108 are only used for providing connection points via the one or more power transmission contacts, such as C1 VCC and C5 GND, to an external power source, and no data is transmitted to or from the smart card 104 during an activation or enrollment process. The smart card 104 may comprise one or more power transmission contacts for connecting the smart card 104 to a power source, without any further data transmission capability as in a secure element. In other embodiments, the location of the biometric sensor 102 may be embedded into any position on the smart card 104 such that the position of the biometric sensor 102 is substantially separated from the contact pads 108 and allows a user to place a finger on the biometric sensor 102.

A user can carry out various functions on the smart card 104 by placing a finger in various positions over a sensing area 106 of the biometric sensor 102. The sensing area 106 comprises a two-dimensional array of sensor elements. Each sensor element is a discrete sensing component which may be enabled depending on the function of the biometric sensor 102. Any combination of sensor elements in the two-dimensional array may be enabled depending on the function of the biometric sensor. While the illustrated embodiment shown in FIG. 1 describes the biometric sensor 102 in relation to the smart card 104, this is not required and the biometric sensor 102, or other biometric sensor, may be incorporated in a different limited device in other embodiments. For example, other limited devices in which aspects of the technology describe herein may be incorporated include fitness monitors, wearable devices, domestic and industrial appliances, automotive components, and “internet of things” (IOT) devices.

In some embodiments, the sensing area 106 can have different shapes including, but not limited to, a rectangle, a circle, an oval, a diamond, a rhombus, or a lozenge.

The biometric sensor 102 may comprise an array of sensor elements comprising a plurality of conductive drive lines and overlapped conductive pickup lines that are separated from the drive lines by a dielectric layer. Each drive line may thus be capacitively coupled to an overlapping pickup line through a dielectric layer. In such embodiments, the pickup lines can form one axis (e.g., X-axis) of the array, while the drive lines form another axis (e.g., Y-axis) of the array. Each location where a drive line and a pickup line overlap may form an impedance-sensitive electrode pair whereby the overlapping portions of the drive and pickup lines form opposed plates of a capacitor separated by a dielectric layer or layers. This impedance-sensitive electrode pair may be treated as a pixel (e.g., an X-Y coordinate) at which a surface feature of the proximally located object is detected. The array or grid forms a plurality of pixels that can collectively create a map of the surface features of the proximally located object. For instance, the sensor elements forming the pixels of the grid produce signals having variations corresponding to features of a fingerprint disposed over the particular sensor element and thus the pixels along with circuitry controlling the sensor elements and processing signals produced by the sensor elements that includes a processor and signal conditioning elements (i.e., “sensor controlling circuitry”) that may be incorporated into an integrated circuit can map locations where there are ridge and valley features of the finger surface touching the sensor array.

In the context of this application, a “data input device” is any device that may be attached or otherwise coupled to a host device and is thereby coupled to a biometric sensor of the host device to enable a user to provide inputs to the host device through the biometric sensor via features of the data input device that allow the user to interface with the biometric sensor to provide control inputs or inputs of data in addition to the particular biometric data that the biometric sensor is configured to detect. For instance, in examples described herein, the data input device includes keys or buttons that are each uniquely coupled to a fingerprint sensor of the host device so that a user contacting any such key or button generates a unique control input or a unique data input corresponding to that key or button. In addition, in other examples described herein, the attachment or coupling of the data input device to the host device, or its removal, may itself provide data input to the host device, for example, communicating that the data input device has been attached or coupled to, or removed from, the host device, that the data input device has or has not been properly positioned with respect to the biometric sensor to enable proper control or data input by the user, or, as described above, to place the biometric sensor in one of a number of operating modes.

In some embodiments, when the biometric sensor 102 is in enrollment mode, all of the sensor elements in the two dimensional array of the sensing area 106 are activated in a fingerprint sensing mode to produce signals—such as capacitance—having detectible variations corresponding to fingerprint features—grooves and ridges—in detective proximity to the sensor array (i.e., in physical contact with the sensor elements or in sufficient proximity to the sensor elements to produce signals corresponding to fingerprint features) which together form an “image” of the fingerprint, and the sensor controlling circuitry is configured so that multiple images of a user's fingerprint may be gathered, and, possibly, manipulated, to acquire a sufficient fingerprint template that may be subsequently stored in memory.

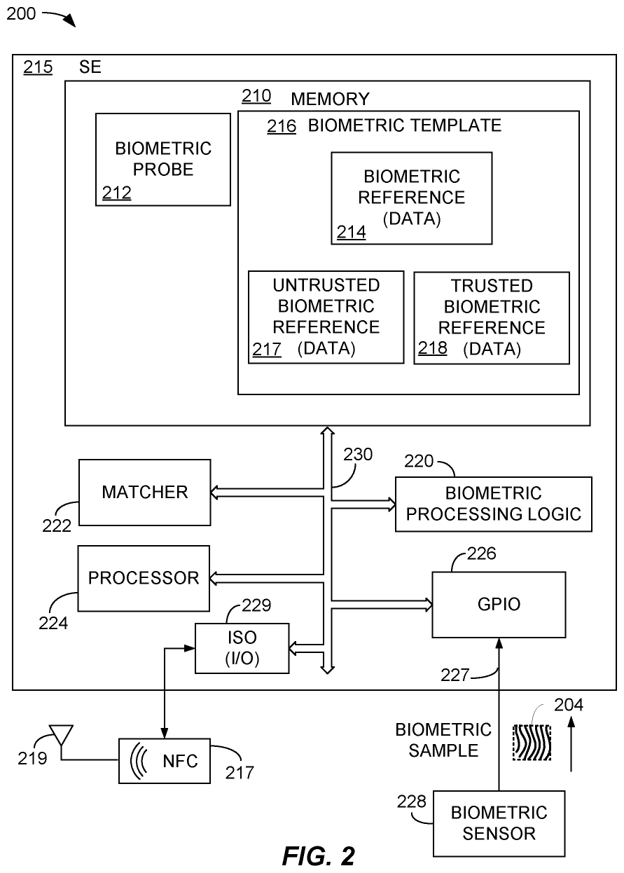

FIG. 2 is a block diagram 200 of a portion of the smart card of FIG. 1. In an exemplary embodiment, the portion of the smart card may comprise a secure element 215. The secure element 215 may be similar to the secure element 115 of FIG. 1. In an exemplary embodiment, the secure element 215 may comprise a processor 224, a memory 210, a matcher 222, biometric processing logic 220, a general purpose input/output (I/O) (GPIO) element 226 and an International Organization for Standardization (ISO) I/O element 229 operatively coupled together over a communication bus 230. A biometric sensor 228 may provide data to the GPIO element 226 over connection 227. For example, the biometric sensor 228 may provide a biometric sample 204 to the GPIO element 226 over connection 227. In an exemplary embodiment, the biometric sensor 228 may be a fingerprint sensor, similar to the biometric sensor 102 of FIG. 1. In an exemplary embodiment, the ISO I/O element 229 may be connected to the NFC element 217. In an exemplary embodiment, an NFC element 217 and antenna 219 may be connected to the SE 215 to allow the smart card (not shown) that is associated with the SE 215 to harvest power wirelessly. The NFC element 217 and the antenna 219 are similar to the NFC element 117 and antenna 119 described in FIG. 1.

In an exemplary embodiment, the memory 210 may be similar to the memory 112 or the memory 132 of FIG. 1. In an exemplary embodiment, the memory 210 may comprise a location 212 for storing one or more biometric probes, and a location for storing one or more biometric templates 216. In an exemplary embodiment, the biometric template 216 may comprise one or more of a location 214 for storing one or more biometric references (also referred to as biometric reference data), a location 217 for storing untrusted biometric reference data and a location 218 for storing trusted biometric reference data.

In an exemplary embodiment, one or more of the location 212 for storing biometric probes and the location 216 for storing one or more biometric templates may be located on secured memory or in unsecured memory. The secured memory may be protected by access control. In an exemplary embodiment, the biometric template 216 may comprise one or more biometric references that may be collected as a user enrolls their biometric information onto their smart card as they perform transactions.

In an exemplary embodiment, the matcher 222 may comprise hardware, software, firmware, or a combination thereof configured to be executed by the processor 224, and may be configured to process samples from the biometric sensor 228 to determine whether a biometric sample provided by the biometric sensor 228 has a sufficient number of correlated features with (and/or matches or partially matches) a biometric reference that may be stored in the memory 210 to allow the determination that the new or live biometric sample provided by the biometric sensor 228 belongs to the same user as does a verified or a trusted biometric reference. In some embodiments, the matching function may reside completely in the SE or parts of the matching function may reside in both an ASIC and the SE, which in some embodiments may be combined into a single element. Biometric sample matching technology is known to those having ordinary skill in the art and will not be described in detail herein. In other embodiments the matcher 222, processor 224, memory 210 and biometric processing logic 220 may reside in the biometric sensor 228.

In an exemplary embodiment, the biometric processing logic 220 may comprise hardware, software, firmware, or a combination thereof configured to be executed by the processor 224, and may be configured to process a biometric sample 204 into a biometric probe 212 and to perform other biometric processing functions as described herein.

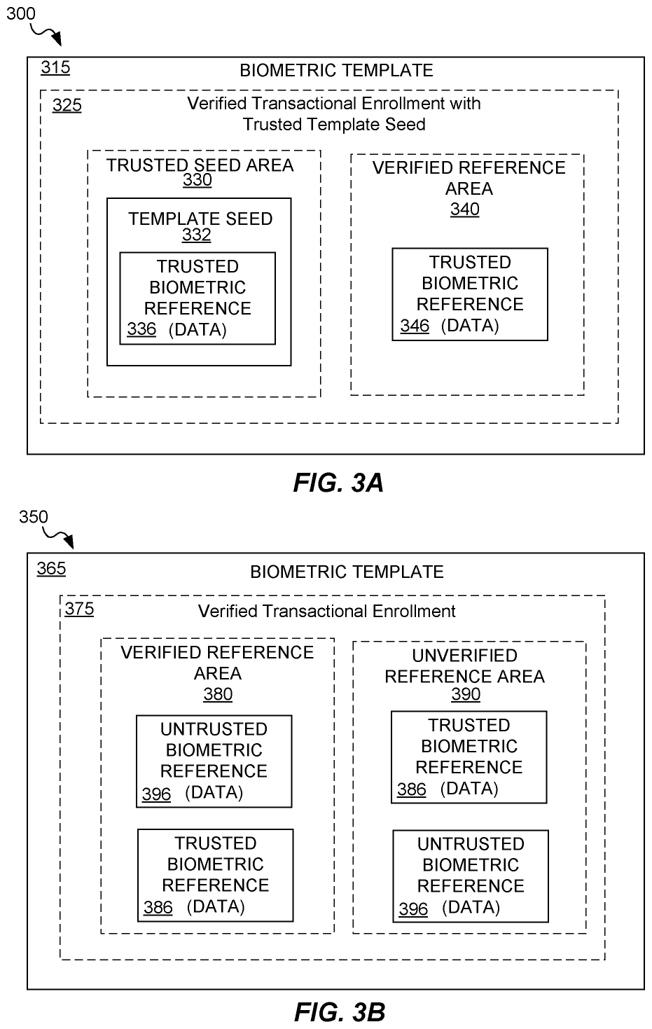

FIG. 3A is a block diagram 300 showing a biometric template 315 used with verified transactional biometric enrollment using a trusted template seed. In an exemplary embodiment, the biometric template 315 comprises a memory location 325 having a trusted seed area 330 and a verified reference area 340. In an exemplary embodiment, the trusted seed area 330 may comprise a template seed 332 having a trusted biometric reference 336. In an exemplary embodiment, a biometric sample may be processed and determined to be a trusted biometric reference 336 as described herein. In an exemplary embodiment, the verified reference area 340 may comprise a trusted biometric reference 346. In an exemplary embodiment, a biometric sample may be processed and determined to be a trusted biometric reference 346 as described herein.

FIG. 3B is a block diagram 350 showing a biometric template 365 used with verified transactional biometric enrollment. In an exemplary embodiment, the biometric template 365 comprises a memory location 375 having a verified reference area 380 and an unverified reference area 390. In an exemplary embodiment, verified reference area 380 may comprise a trusted biometric reference 386 and/or an untrusted biometric reference 396. In an exemplary embodiment, a biometric sample may be processed and determined to be a trusted biometric reference 386 as described herein. In an exemplary embodiment, unverified reference area 390 may comprise an untrusted biometric reference 396 and/or a trusted biometric reference 386. In an exemplary embodiment, a biometric sample may be processed and determined to be an trusted untrusted biometric reference 386 as described herein.

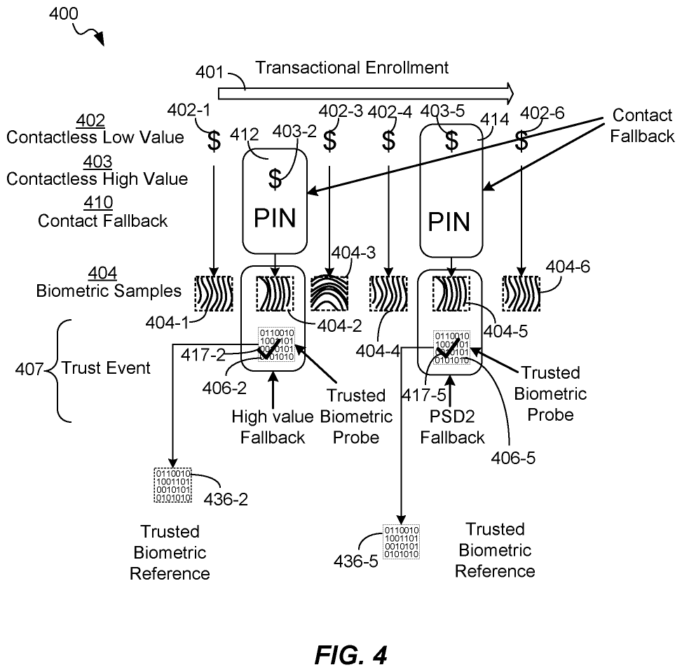

FIG. 4 is a diagram 400 showing an exemplary embodiment of transactional biometric enrollment with on-card trust establishment. The diagram 400 shows one example of the manner in which a trusted biometric reference may be created. The diagram 400 shows a transactional enrollment timeline (or phase) 401 during which contactless low value transactions 402 and contactless high value transactions 403 may be made. The terms “low-value transaction” and “high-value transaction” are relative and can encompass any values. For example, a biometric sample 404-1 may be collected during a first contactless low value transaction 402-1. Because the transaction is considered a low-value transaction, the biometric sample 404-1 is not considered to be capable of being processed into a trusted biometric reference because no trust event would occur during the transaction. An example of a trust event may include the entry of a PIN, or other identity verification process during a transaction that may create a trusted biometric reference from a biometric probe.

In an exemplary embodiment, a biometric sample 404-2 may be collected during a contactless high value transaction 403-2. Because the transaction is considered a high-value transaction and because there is no biometric template established yet, the transaction is referred to as a contact fallback transaction 412. A contact fallback transaction 412 may be what is referred to as a “PIN fallback” transaction, which means that to complete the transaction a contact event and entry of a secondary identifier should occur to approve the transaction. A secondary identifier may be, for example, a PIN entered on a point of sale (POS) terminal in which the smart card 104 may be in contact. Another mechanism for providing additional authentication may also be referred to as a “PSD2” (payment services directive 2) transaction, which occurs when a card issuing bank or other financial authority requires strong customer authentication, such as a form of dual authentication, and initiates such dual authentication in the form of a PSD2 transaction.

For example, at a prompt generated by a POS terminal with which the smart card 104 is communicating, the user may be asked to insert the smart card 104 into a card reader and enter a personal identification number (PIN) to authorize the transaction. This so-called PIN fallback event can then be used to confirm the identity of the user and allow the biometric processing logic 220 (FIG. 2) to create a trust establishment event, or trust event 417-2, for the biometric sample 403-2. In this manner, a biometric probe 406-2 corresponding to the biometric sample 403-2 may be considered trusted and can be used to generate a trusted biometric reference 436-2. In some exemplary embodiments, the trusted biometric reference 436-2 may be used as a template seed. In an exemplary embodiment, the biometric probe 406-2, and all biometric probes 406 described herein, are processed by the biometric processing logic 220 (FIG. 2), the operation of which is generally shown using reference numeral 407.

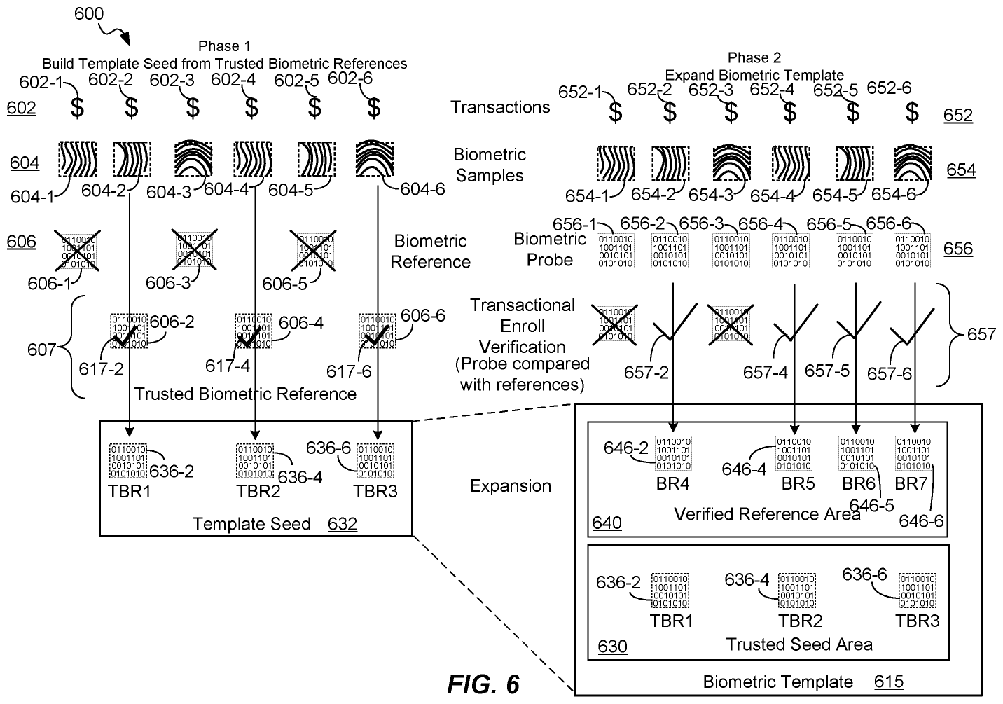

In an exemplary embodiment, biometric samples 404-3 and 404-4 may be collected during a subsequent contactless low value transactions 402-3 and 402-4. Because the transactions are considered low-value transactions, the biometric samples 404-3 and 404-4 are not considered to be capable of being processed into trusted biometric references. However, if they match against a trusted seed (see e.g., FIG. 6), they may be considered verified biometric references until a trust event occurs, after which they may be considered trusted biometric references.

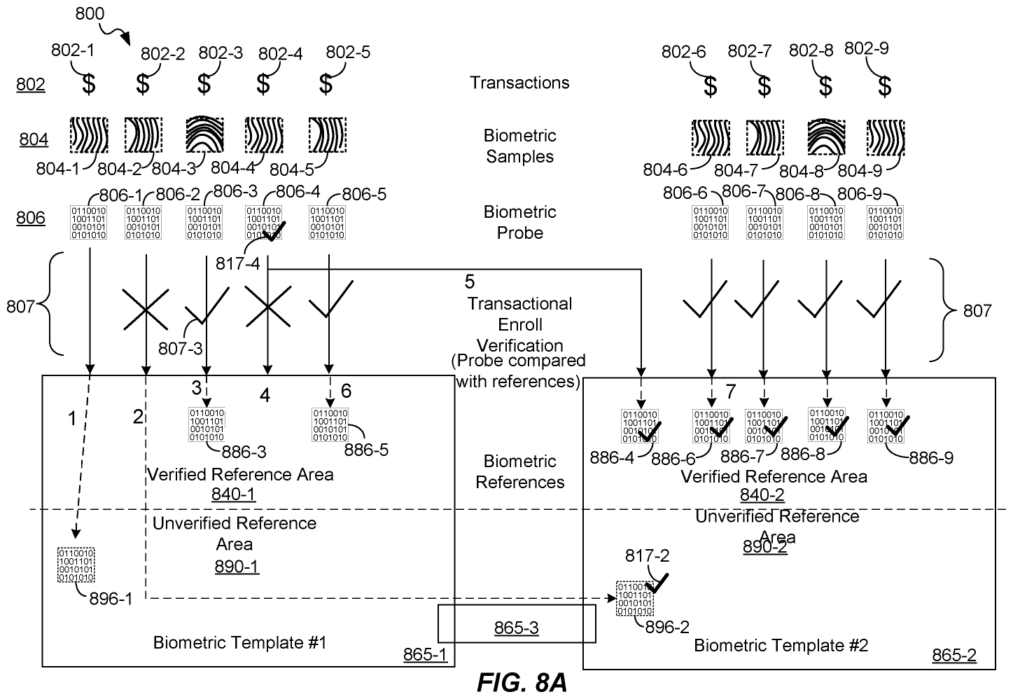

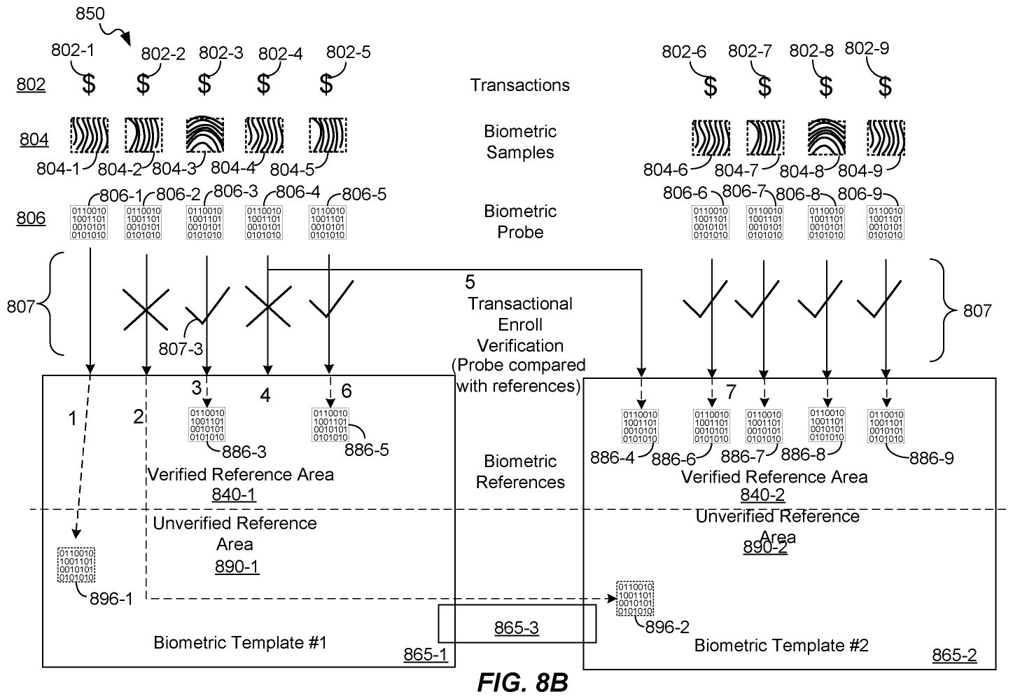

In an exemplary embodiment, a biometric sample 404-5 may be collected during a contactless high value transaction 403-5. Because the transaction is considered a high-value transaction and because there is no biometric template established yet (or the biometric sample 404-5 does not match any biometric reference in an existing biometric template), then a new biometric template may be created (see, e.g., FIGS. 8A and 8B) the transaction is referred to as a contact fallback transaction 414. In this example, the contact fallback transaction 414 may be what is referred to as a “PSD2” transaction. This so-called contact fallback event can then be used to confirm the identity of the user and to create a trust establishment event 417-5 for the biometric sample 404-5. In this manner, a biometric probe 406-5 corresponding to the biometric sample 404-5 may be considered trusted and can be used to generate a trusted biometric reference 436-5. In some exemplary embodiments, the trusted biometric reference 436-5 may be used as a template seed.

Another biometric sample 404-6 may be collected during a subsequent contactless low value transaction 402-6. Because the transaction is considered a low-value transaction, the biometric sample 404-6 is not considered to be capable of being processed into a trusted biometric reference.

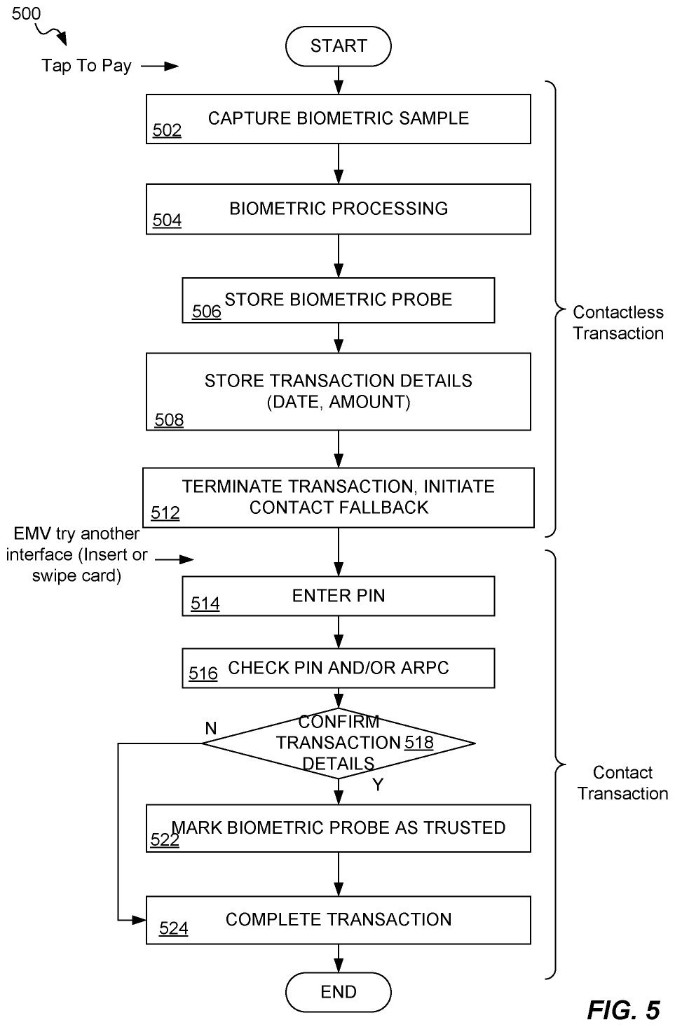

FIG. 5 is a flow chart showing a method 500 for transactional biometric enrollment with on-card trust establishment. The blocks in the method 500 can be performed in or out of the order shown and some blocks may be performed in parallel.

In block 502, a biometric sample is captured. For example, a biometric sample 404-2 may be captured during a contactless transaction 403-2. In this example, the contactless transaction 403-2 is a high value contact less transaction.

In block 504, the biometric sample 404-2 is processed to create a biometric probe. For example, the biometric sample 404-2 may be processed by the biometric processing logic 220 (FIG. 2) into a biometric probe 406-2.

In block 506, the biometric probe 406-2 is stored. For example, the biometric probe 406-2 may be stored in the memory 210 (FIG. 2).

In block 508, transaction details related to a transaction are stored. For example, the date, time, amount, and other information related to the transaction 402-2 may be stored in the memory 210 (FIG. 2).

In block 512, the contactless transaction 403-2 is terminated and a contact fallback may be initiated. For example, the contactless transaction 403-2 may be for a dollar amount that exceeds a certain threshold established for a contactless transaction. In such an instance, a contact fallback transaction with PIN entry may be initiated. For example, a contact fallback transaction 412 (FIG. 4) may be initiated.

In block 514, a contact transaction is established and in this exemplary embodiment the user is requested to enter a PIN.

In block 516, in the case of offline authorization, the users PIN is checked by the secure element 215 (FIG. 2) and the secure element 215 generates a corresponding cryptogram to acknowledge the transaction approval. In case of an online authorization, the secure element 215 receives an ARPC (Authorization Response Cryptogram) response which indicates successful online authorization of the transaction.

In block 518, the transaction details (e.g., date, time, amount, and other information related to the transaction 402-2) are checked. If the transaction details are confirmed, then the process proceeds to block 522. If the transaction details are not confirmed, then the biometric probe is not considered trusted and the process proceeds to block 524 where the transaction completes.

In block 522, if the transaction details are confirmed, the biometric probe 406-2 is considered trusted and is saved as a trusted biometric reference 436-2.

In block 524, the transaction 402-2 is complete.

FIG. 6 is a diagram 600 showing an exemplary embodiment of verified transactional biometric enrollment using a trusted template seed. The diagram 600 describes transactional biometric enrollment with on-card trust establishment. A first phase shown on the left side of the diagram 600 shows transactions 602, biometric samples 604, biometric references 606, biometric transactional enrollment verification events 607 and a template seed 632. The biometric samples 604 may be examples of the biometric sample 204 of FIG. 2 and the template seed 632 may be an example of the template seed 332 of FIG. 3A.

A second phase shown on the right side of the diagram 600 shows transactions 652, biometric samples 654, biometric probes 656, biometric transactional enrollment verification events 657, and a biometric template 615. In an exemplary embodiment, the biometric template 615 may comprise a trusted seed area 630 and a verified reference area 640. The biometric template 615 may be an example of the biometric template 315 of FIG. 3A, the trusted seed area 630 may be an example of the trusted seed area 330 of FIG. 3A, and the verified reference area 640 may be an example of the verified reference area 340 of FIG. 3A.

In an exemplary embodiment, the template seed 632 may comprise one or more trusted biometric references, exemplary ones of which are illustrated using reference numerals 636-2, 636-4 and 636-6. The trusted biometric references 636-2, 636-4 and 636-6 may be examples of the trusted biometric reference 336 of FIG. 3A.

In an exemplary embodiment, the trusted seed area 630 in the biometric template 615 stores the trusted biometric references 636-2, 636-4 and 636-6 from the template seed 632. In an exemplary embodiment, the verified reference area 640 in the biometric template 615 stores additional biometric references, exemplary ones of which are illustrated using reference numeral 646-2, 646-4, 646-5 and 646-6, added to the biometric template 615 through a biometric template expansion process described herein.

In an exemplary embodiment, in phase 1, the template seed 632 is built using trusted biometric references. An example of the way in which the template seed 632 is seeded with trusted biometric references is described in FIGS. 4 and 5 herein. For example, a transaction 602-1 occurs during which a biometric sample 604-1 is captured by a smart card. The biometric sample 604-1 is processed as described above in FIGS. 4 and 5 to determine whether it is to be included in the template seed 632. For example, the biometric probe 606-1 is determined to not be a trusted biometric reference and is not made part of the template seed 632. However, captured as part of a subsequent transaction 602-2, a biometric probe 606-2 is generated from the biometric sample 604-2, and is determined to be a trusted biometric reference having a trust event 617-2, which is shown as trusted biometric reference 636-2 in the template seed 632. The template seed 632 is built with trusted biometric references 636-4 and 636-6 in a similar manner. In an exemplary embodiment, the biometric probe 606-1, and all biometric probes 606 described herein, are generated from biometric samples 604 by the biometric processing logic 220 (FIG. 2), the operation of which is generally shown using reference numeral 607.

In an exemplary embodiment, in phase 2, the biometric template 615 may be expanded. For example, subsequent transactions 652 occur during which subsequent biometric samples 654 are captured by a smart card. For each biometric sample 654 captured by the smart card, a biometric probe 656 is created which is compared with the trusted biometric references 636 in the trusted seed area 630 and with any verified biometric references in the verified reference area 640. If a biometric probe 656 matches a trusted biometric reference 636 or matches any verified biometric references in the verified reference area 640, the biometric probe 656 is added to the verified reference area 640 as a trusted biometric reference 646. For example, in a subsequent transaction 652-1, a biometric sample 654-1 may be captured and a biometric probe 656-1 created. The biometric probe 656-1 is compared against the trusted biometric references 636-2, 636-4 and 636-6 in the trusted seed area 630. If the biometric probe 656-1 fails to match any of the trusted biometric references 636-2, 636-4 and 636-6 in the trusted seed area 630, the biometric probe 656-1 fails the biometric transactional enrollment verification event 657 and is discarded.

In another subsequent transaction 652-2, another biometric sample 654-2 may be captured and a corresponding biometric probe 656-2 created. The biometric probe 656-2 is compared against the trusted biometric samples 636-2, 636-4 and 636-6 in the trusted seed area 630 and any verified biometric references in the verified reference area 640. If the biometric probe 656-2 matches any of the trusted biometric samples 636-2, 636-4 and 636-6 in the trusted seed area 630 or any verified biometric references in the verified reference area 640, the biometric probe 656-2 passes the biometric transactional enrollment verification event 657-2 and is added as a verified biometric reference 646-2 in the verified reference area 640. Subsequent transactions 652 give rise to the capture of subsequent biometric samples 654 from which subsequent biometric probes 656 are created and compared against the trusted biometric samples 636-2, 636-4 and 636-6 in the trusted seed area 630 and against the verified biometric reference 646-2 in the verified reference area 640. In this manner, matching subsequent biometric probes 656-4, 656-5 and 656-6 are added to the verified reference area 640 as verified biometric references 646-4, 646-5 and 646-6.

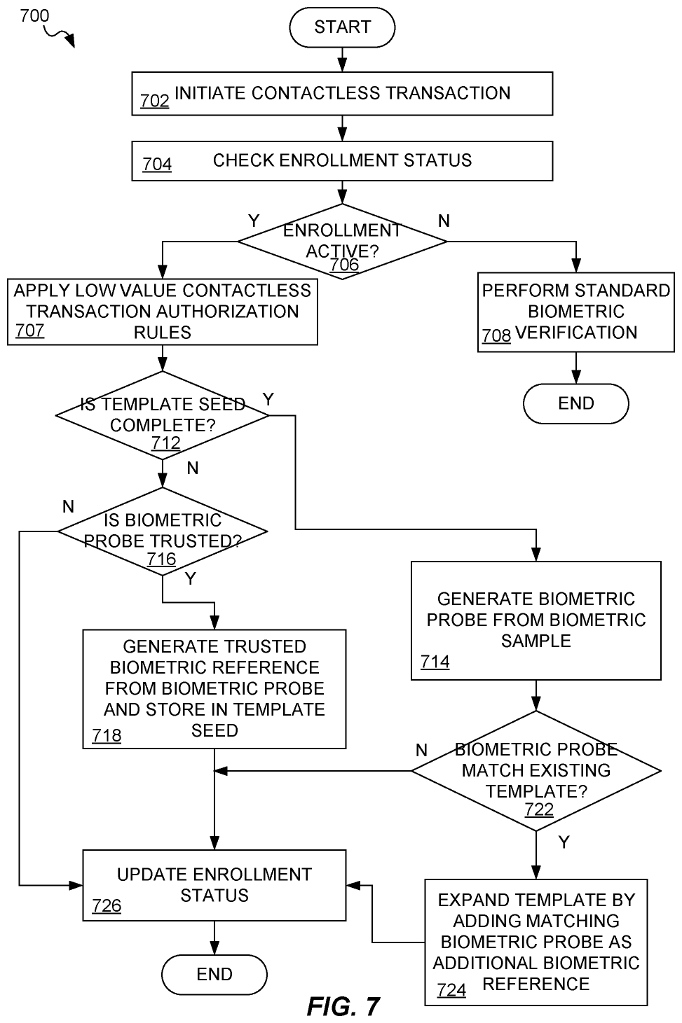

FIG. 7 is a flow chart showing an exemplary embodiment of a method 700 for verified transactional biometric enrollment using a trusted template seed. The blocks in the method 700 can be performed in or out of the order shown and some blocks may be performed in parallel. The blocks in the flow chart 700 may be performed on a smart card, such as the smart card 104 of FIG. 1.

In block 702 a contactless transaction is initiated. For example, a user may initiate a transaction at a POS terminal using a smart card during which a biometric sample 604 (FIG. 6) may be captured.

In block 704, the smart card 104 checks the status of the user's enrollment.

For example, the smart card 104 may already be fully enrolled, after which standard biometric verification is performed. Alternatively, enrollment is not desired, for example, if using the smart card 104 as a non-biometric card, or if enrollment is not enabled at a specific point in time (requires PIN or other user authentication action). Alternatively, it may be determined that transactional biometric enrollment is active.

In block 706, it is determined whether enrollment is active. For example, the biometric processing logic 220 in the smart card 104 may check the memory 210 to determine enrollment status.

If it is determined in block 706 that enrollment is not active, then in block 708 the smart card 104 performs standard biometric verification using appropriate transaction limits and the process ends.

If it is determined in block 706 that enrollment is active, then in block 707 low value contactless transaction authorization rules are applied to the current transaction by the card management, authorization and fraud module 1032 in the issuing bank system 1020 and the process proceeds to block 712.

In block 712 it is determined whether the template seed is complete. For example, the biometric processing logic 220 in the smart card 104 may examine the template seed 632 to determine whether it is complete. For example, the number of trusted biometric references that define a complete template seed may be a configurable value based on a number of factors, such as, for example, the quality of the biometric references collected early in the enrollment process.

If it is determined in block 712 that the template seed is complete, the process proceeds to block 714. If it is determined in block 712 that the template seed is not complete, the process proceeds to block 716.

In block 714, a biometric probe is generated from the biometric sample. For example, a biometric probe 606-1 may be generated from a biometric sample 604-1. A biometric reference may be added to the verified reference area 640 (FIG. 6) if there was a positive match against a biometric reference in the trusted seed area 630 (FIG. 6). Biometric samples that do not match against a trusted seed are discarded.

In block 722, it is determined whether the biometric probe matches an existing template. For example, it may be determined by the matcher 222 (FIG. 2) whether the biometric probe 606-1 matches a biometric reference in the biometric template 615. In some embodiments, additional determinations may be performed, such as, for example, to assess the amount of new information compared to biometric references that are already enrolled, the quality of the biometric probe, and other items.

If it is determined in block 722 that the biometric probe matches an existing template, then in block 724 the biometric template is expanded by adding the matching biometric probe as an additional biometric reference. For example, a biometric probe 656-2 may be added to the biometric template 615 as a verified biometric reference 646-2. For example, if a biometric probe matches against one of the existing biometric references in the trusted seed area 630 or the verified reference area 640, the biometric probe is added to the verified reference area 640.

The comparison of a biometric probe to a reference in the template 615 includes template quality checks for sufficient new biometric information in addition to match/no-match checks.

If it is determined in block 722 that the biometric probe does not match an existing template, then the biometric probe is discarded and the process proceeds to block 726 where the user's enrollment status is updated. For example, the enrollment status update may consider the obtaining of a trusted seed template, having a successful match against trusted seeds or verified references, rejecting non-trusted or non-matching references, etc. The enrollment progress is reviewed against completion of trusted seed enrollment, completion of biometric template expansion, and the updated enrollment status may be used during the next payment transaction.

In block 716, it is determined whether the biometric probe is trusted. For example, it is determined whether a PIN entry or an ARPC response may have been provided to create trust in the biometric probe.

If it is determined in block 716 that the biometric probe is trusted, then in block 718, a trusted biometric reference is generated and stored in the biometric template seed 632. For example, a biometric sample 604-2 may be used to generate a biometric probe 606-2, which is considered trusted and is placed in the template seed 632 as a trusted biometric reference 636-2.

If it is determined in block 716 that the biometric sample is not trusted, then the process proceeds to block 726 where the biometric probe is discarded and the user's enrollment status is updated, as described above.

FIG. 8A is a diagram 800 showing an exemplary embodiment of verified transactional biometric enrollment. The diagram 800 describes an exemplary embodiment of transactional biometric enrollment with on-card trust establishment. In the example shown in FIG. 8A, multiple biometric templates may be created. The diagram 800 shows transactions 802, biometric samples 804, biometric references 806, biometric transactional enrollment verification events 807, a first biometric template 865-1 and a second biometric template 865-2. Although two biometric templates 865-1 and 865-2 are shown in FIG. 8A, more than two biometric templates are possible. The biometric samples 804 may be examples of the biometric sample 204 of FIG. 2 and the biometric templates 815-1 and 815-2 may be examples of the biometric template 365 of FIG. 3B.

In an exemplary embodiment, a biometric sample 804-1 is captured during a transaction 802-1. The biometric processing logic 220 (FIG. 2) generates a biometric probe 806-1 from the biometric sample 804-1. Because this is the first transaction, and in this example the first transaction 802-1 does not include a trust event, the biometric probe 806-1 is considered an untrusted biometric reference and is stored in the unverified reference area 890-1 as an untrusted biometric reference 896-1. If a trust event occurs as part of the first transaction 802-1, then the biometric probe 806-1 may be considered to be a trusted biometric reference. In an exemplary embodiment, the biometric probe 806-1, and all biometric probes 806 described herein, are processed by the biometric processing logic 220 (FIG. 2), the operation of which is generally shown using reference numeral 807.

A second biometric sample 804-2 is captured during a second, or subsequent, transaction 802-2. The biometric processing logic 220 (FIG. 2) generates a biometric probe 806-2 from the biometric sample 804-2. The biometric probe 806-2 is compared against the untrusted biometric reference 896-1. In this example, the biometric probe 806-2 does not match the untrusted biometric reference 896-1 and is saved in the biometric template 865-2 as an untrusted biometric reference 896-2 in the unverified reference area 890-2. In this manner, the second biometric template 865-2 is created because the biometric probe 806-2 does not match the untrusted biometric reference 896-1 in the first biometric template 865-1. However, the second biometric template 865-2 remains untrusted. This situation may be an example of the enrollment of a second finger. For example, the biometric sample 804-1 and the biometric probe 806-1 may correspond to a first finger and the biometric sample 804-2 and the biometric probe 806-2 may correspond to a second finger.

In an exemplary embodiment, a third biometric sample 804-3 is captured during a third, or subsequent, transaction 802-3. The biometric processing logic 220 (FIG. 2) generates a biometric probe 806-3 from the biometric sample 804-3. The biometric probe 806-3 is compared against the untrusted biometric reference 896-1 in the first biometric template 865-1 and the untrusted biometric reference 896-2 in the second biometric template 865-2. In this example, the biometric probe 806-3 matches the untrusted biometric reference 896-1 (e.g., passes the biometric transactional enrollment verification event 807-3) and is saved in the biometric template 865-1 as a verified biometric reference 886-3 in the verified reference area 840-1. In this manner, the first biometric template 865-1 is expanded because the biometric probe 806-3 does match the untrusted biometric reference 896-1.

A fourth biometric sample 804-4 is captured during a fourth, or subsequent, transaction 802-4. The biometric processing logic 220 (FIG. 2) generates a biometric probe 806-4 from the biometric sample 804-4. The biometric probe 806-4 is compared against the untrusted biometric reference 896-1, the verified biometric reference 886-3 and the untrusted biometric reference 896-2. In this example, the biometric probe 806-4 is a trusted biometric sample because a trust event 817-4 occurred and because it matches the untrusted biometric reference 896-2 and it is saved in the biometric template 865-2 as a trusted biometric reference 886-4 in the verified reference area 840-2 and the biometric template 865-2 becomes trusted. Because the untrusted biometric reference 896-2 matches the now trusted biometric reference 886-4, the untrusted biometric reference 896-2 now becomes trusted as shown by trust event 817-2. In this manner, the second biometric template 865-2 is expanded and becomes a trusted biometric template because the biometric probe 806-4 is a trusted biometric reference 886-4 and does match the untrusted biometric reference 896-2, which is now trusted. In an exemplary embodiment, a fifth biometric sample 804-5 is captured during a fifth, or subsequent, transaction 802-5. The biometric processing logic 220 (FIG. 2) generates a biometric probe 806-5 from the biometric sample 804-5. The biometric probe 806-5 is compared against the untrusted biometric reference 896-1, the trusted biometric reference 886-3, the now trusted biometric reference 896-2 and the trusted biometric reference 886-4. In this example, the biometric probe 806-5 matches the untrusted biometric reference 896-1 and is saved in the biometric template 865-1 as a verified biometric reference 886-5 in the verified reference area 840-1. In this manner, the first biometric template 865-1 is expanded because the biometric probe 806-5 does match the untrusted biometric reference 896-1 and/or the trusted biometric reference 886-3.

In an exemplary embodiment, sixth, seventh, eighth and ninth biometric samples 804-6, 804-7, 804-8 and 804-9 are captured during sixth, seventh, eighth and ninth subsequent transactions 802-6, 802-7, 802-8 and 802-9. Corresponding biometric probes 806-6, 806-7, 806-8 and 806-9 are generated as described above and compared against the untrusted biometric reference 896-1, the trusted biometric references 886-3 and 886-5, the trusted biometric reference 896-2 and the trusted biometric reference 886-4. In this example, the biometric probes 806-6, 806-7, 806-8 and 806-9 all match at least one of the trusted biometric reference 886-4 and the trusted biometric reference 896-2 (and any of the trusted biometric references in the verified reference area 840-2) and are saved in the second biometric template 865-2 as trusted biometric references 886-6, 886-7, 886-8 and 886-9 in the verified reference area 840-2. In this manner, the second biometric template 865-2 is expanded because the biometric probes 806-6, 806-7, 806-8 and 806-9 do match the trusted biometric reference 896-2 and/or the trusted biometric reference 886-4.

FIG. 8B is a diagram 850 showing an exemplary embodiment of verified transactional biometric enrollment. The diagram 850 is similar to the diagram 800 of FIG. 8A, but describes an exemplary embodiment of transactional biometric enrollment with on-line trust establishment. In the example shown in FIG. 8B, multiple biometric templates may be created. The diagram 850 shows transactions 802, biometric samples 804, biometric references 806, biometric transactional enrollment verification events 807, a first biometric template 865-1 and a second biometric template 865-2. Although two biometric templates 865-1 and 865-2 are shown in FIG. 8B, more than two biometric templates are possible. The biometric samples 804 may be examples of the biometric sample 204 of FIG. 2 and the biometric templates 815-1 and 815-2 may be examples of the biometric template 365 of FIG. 3B.

In an exemplary embodiment, a biometric sample 804-1 is captured during a transaction 802-1. The biometric processing logic 220 (FIG. 2) generates a biometric probe 806-1 from the biometric sample 804-1. Because in this exemplary embodiment, the smart card 104 does not consider any trust events and the biometric probe 806-1 is considered an untrusted biometric reference, it is stored in the unverified reference area 890-1 as an untrusted biometric reference 896-1. In an exemplary embodiment, the biometric probe 806-1, and all biometric probes 806 described herein, are processed by the biometric processing logic 220 (FIG. 2), the operation of which is generally shown using reference numeral 807.

A second biometric sample 804-2 is captured during a second, or subsequent, transaction 802-2. The biometric processing logic 220 (FIG. 2) generates a biometric probe 806-2 from the biometric sample 804-2. The biometric probe 806-2 is compared against the untrusted biometric reference 896-1. In this example, the biometric probe 806-2 does not match the untrusted biometric reference 896-1 and is saved in the biometric template 865-2 as an untrusted biometric reference 896-2 in the unverified reference area 890-2. In this manner, the second biometric template 865-2 is created because the biometric probe 806-2 does not match the untrusted biometric reference 896-1 in the first biometric template 865-1. This situation may also be an example of the enrollment of a second finger. For example, the biometric sample 804-1 and the biometric probe 806-1 may correspond to a first finger and the biometric sample 804-2 and the biometric probe 806-2 may correspond to a second finger.

In an exemplary embodiment, a third biometric sample 804-3 is captured during a third, or subsequent, transaction 802-3. The biometric processing logic 220 (FIG. 2) generates a biometric probe 806-3 from the biometric sample 804-3. The biometric probe 806-3 is compared against the untrusted biometric reference 896-1 in the first biometric template 865-1 and the untrusted biometric reference 896-2 in the second biometric template 865-2. In this example, the biometric probe 806-3 matches the untrusted biometric reference 896-1 (e.g., passes the biometric transactional enrollment verification event 807-3) and is saved in the biometric template 865-1 as a verified biometric reference 886-3 in the verified reference area 840-1. In this manner, the first biometric template 865-1 is expanded because the biometric probe 806-3 does match the untrusted biometric reference 896-1.

A fourth biometric sample 804-4 is captured during a fourth, or subsequent, transaction 802-4. The biometric processing logic 220 (FIG. 2) generates a biometric probe 806-4 from the biometric sample 804-4. The biometric probe 806-4 is compared against the untrusted biometric reference 896-1, the verified biometric reference 886-3 and the untrusted biometric reference 896-2.

Because the biometric probe 806-4 matches the untrusted biometric reference 896-2, it is saved in the biometric template 865-2 as a verified (but not trusted) biometric reference 886-4 in the verified reference area 840-2. However, the biometric template 865-2 remains untrusted. In this exemplary embodiment, trust may be established by a card issuing system (also referred to as a banking back end) and not on the smart card 104.

In an exemplary embodiment, a fifth biometric sample 804-5 is captured during a fifth, or subsequent, transaction 802-5. The biometric processing logic 220 (FIG. 2) generates a biometric probe 806-5 from the biometric sample 804-5. The biometric probe 806-5 is compared against the untrusted biometric reference 896-1, the untrusted biometric reference 886-3, the untrusted biometric reference 896-2 and the untrusted biometric reference 886-4. In this example, the biometric probe 806-5 matches the untrusted biometric reference 896-1 and is saved in the biometric template 865-1 as a verified biometric reference 886-5 in the verified reference area 840-1. In this manner, the first biometric template 865-1 is expanded because the biometric probe 806-5 does match the untrusted biometric reference 896-1 and/or the untrusted biometric reference 886-3.

In an exemplary embodiment, sixth, seventh, eighth and ninth biometric samples 804-6, 804-7, 804-8 and 804-9 are captured during sixth, seventh, eighth and ninth subsequent transactions 802-6, 802-7, 802-8 and 802-9. Corresponding biometric probes 806-6, 806-7, 806-8 and 806-9 are generated as described above and compared against the untrusted biometric reference 896-1, the untrusted biometric references 886-3 and 886-5, the untrusted biometric reference 896-2 and the untrusted biometric reference 886-4. In this example, the biometric probes 806-6, 806-7, 806-8 and 806-9 all match at least one of the untrusted biometric reference 886-4 and the untrusted biometric reference 896-2 (and any of the untrusted biometric references in the verified reference area 840-2) and are saved in the second biometric template 865-2 as verified (but untrusted) biometric references 886-6, 886-7, 886-8 and 886-9 in the verified reference area 840-2. In this manner, the second biometric template 865-2 is expanded because the biometric probes 806-6, 806-7, 806-8 and 806-9 do match the untrusted biometric reference 896-2 and/or the untrusted biometric reference 886-4.

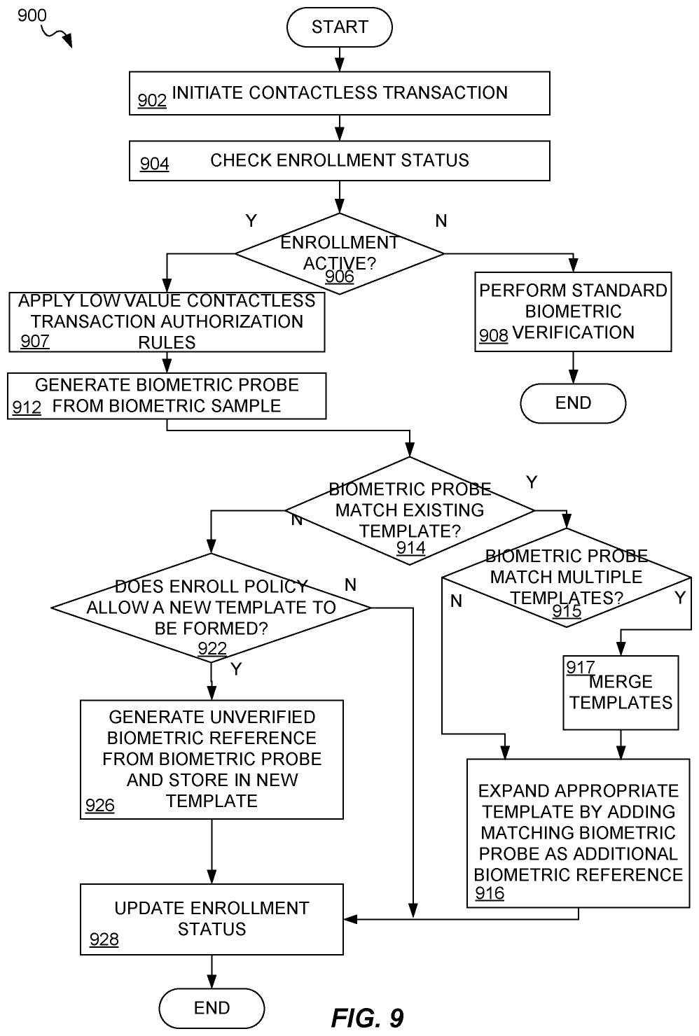

FIG. 9 is a flow chart of an exemplary embodiment of a method 900 for verified transactional biometric enrollment. The blocks in the method 900 can be performed in or out of the order shown and some blocks may be performed in parallel. The blocks in the flow chart 900 may be performed on a smart card, such as the smart card 104 of FIG. 1.

In block 902 a contactless transaction is initiated. For example, a user may initiate a transaction at a POS terminal using a smart card during which a biometric sample 804 (FIG. 8A, 8B) may be captured.

In block 904, the biometric processing logic 220 on the smart card 104 checks the status of the user's enrollment as described above.

In block 906, it is determined whether enrollment is active. For example, the biometric processing logic 220 in the smart card 104 may check the memory 210 to determine enrollment status, as described above.

If it is determined in block 906 that enrollment is not active, then in block 908 the smart card 104 performs standard biometric verification as described above and the process ends.

If it is determined in block 906 that enrollment is active, then in block 907 low value contactless transaction authorization rules are applied to the current transaction by the card management, authorization and fraud module 1032 in the issuing bank system 1020 and the process proceeds to block 912.

In block 912 a biometric probe is generated from the biometric sample. For example, a biometric probe 806-1 may be generated from a biometric sample 804-1.

In block 914, it is determined whether the biometric probe matches an existing template. For example, it may be determined whether the biometric probe 806-1 matches a biometric reference in the biometric template 865-1.

If it is determined in block 914 that the biometric probe matches an existing template, then in block 915 it is determined whether the biometric probe matches multiple biometric templates. For example, it may be determined whether the biometric probe 806-1 matches a biometric reference in the biometric template 865-1 and/or the biometric template 865-2.

If it is determined in block 915 that the biometric probe matches multiple biometric templates, then in block 917 the templates are merged into a third biometric template 865-3. For example, if the biometric probe 806-1 matches a biometric reference in the biometric template 865-1 and in the biometric template 865-2, a merged biometric template 865-3 may be created and the first biometric template 865-1 and the second biometric template 865-2 may be removed.

If it is determined in block 915 that the biometric probe does not match multiple templates, then in block 916 the biometric template is expanded by adding the matching biometric probe as an additional biometric reference. For example, a biometric probe 806-3 may be added to the biometric template 865-1 as a biometric reference 886-3.

If it is determined in block 914 that the biometric probe does not match an existing template, then the process proceeds to block 922, where it is determined whether the enrollment policy on the smart card 104 allows a new template to be formed.

If it is determined in block 922 that the enrollment policy does not allow a new template to be formed, then the process proceeds to block 928 where the user's enrollment status is updated. For example, the enrollment status update may consider whether a biometric probe has a successful match against verified or unverified biometric references; policies regarding creation of new biometric templates; obtaining a trusted biometric probe and marking the corresponding biometric template as trusted. The enrollment progress may be reviewed against at least one trusted biometric template; and having sufficient biometric references in a trusted biometric template area. The updated enrollment status may be used during a subsequent payment transaction.

If it is determined in block 922 that the enrollment policy does allow a new template to be formed, then in block 926 an unverified biometric reference is generated from the biometric probe and stored in a new template. For example, a biometric reference 896-2 may be generated from the biometric probe 806-2 and may be stored in the second biometric template 865-2 as unverified biometric reference 896-2.

In block 928, the user's enrollment status is updated as described above.

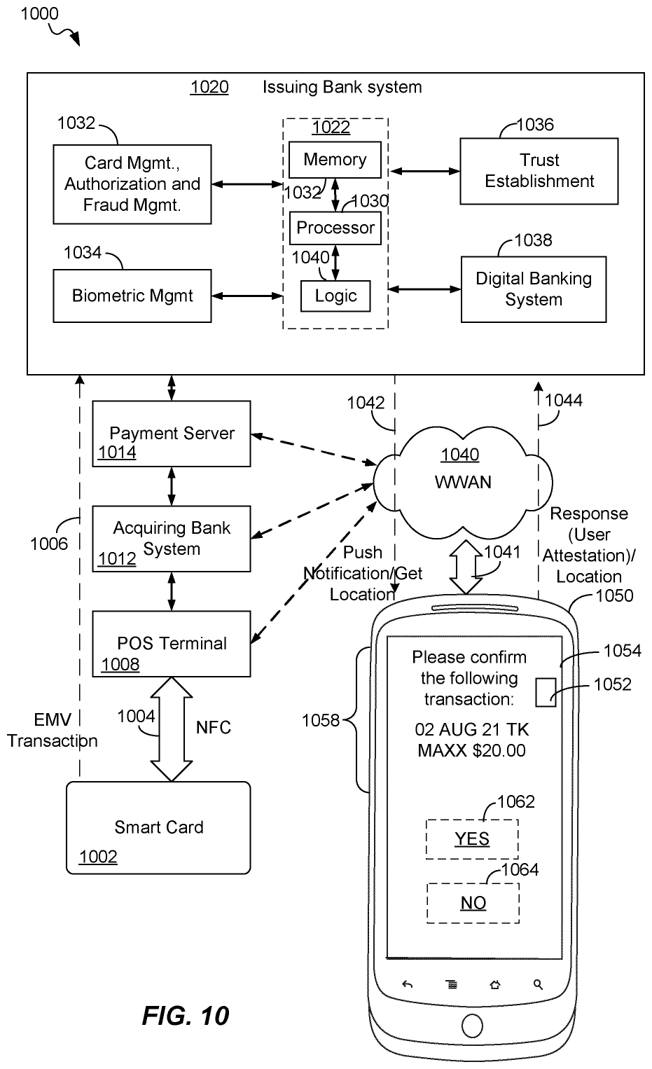

FIG. 10 is a diagram 1000 showing an exemplary embodiment of verified transactional biometric enrollment. The diagram 1000 describes exemplary embodiments of transactional biometric enrollment with interactive on-line trust establishment and with non-interactive on-line trust establishment.

In an exemplary embodiment, a smart card 1002 may interact with a point-of-sale (POS) terminal 1008 over, for example, a non-contact interface such as an NFC interface 1004. In other embodiments, the smart card 1002 may interact with the POS terminal using a contact interface.

The POS terminal 1008 may be in communication with an acquiring bank system 1012, which may be in communication with a payment server 1014. For example, an EMV payment transaction is set up by a merchant on their POS terminal. The POS terminal communicates with the smart card over the NFC interface. The transaction goes generally back to the issuing bank system 1020 for online authorization. To do so, the transaction is routed through the acquiring bank system 1012, which is the bank where the merchant has their account. The transaction then goes through the payment server 1014 back to the issuing bank system 1020 that issued the card. As part of fraud management, the issuing bank system 1020 sends a push notification to the card owner's mobile phone to confirm that the phone owner is performing the payment transaction. Upon successful confirmation, the issuing bank system 1020 informs the acquiring bank system 1012 that the transaction has been authorized (subject to other checks such as funds).

In an exemplary embodiment, the POS terminal 1008, the acquiring bank system 1012 and the payment server 1014 when used to process a transaction using the smart card 1002 may comprise or form part of what is referred to as an EMV transaction 1006.

The payment server 1014 may be in communication with an issuing bank system 1020. In an exemplary embodiment, the issuing bank system 1020 may be associated with the financial institution that issued the smart card 104. A smart phone 1050 may also be in communication with the issuing bank system 1020 over a network 1040. In some embodiments, some or all of the communication comprising the EMV transaction 1006 may also occur over some or all of the network 1040.

As used herein, the term “network” for the network 1040 may comprise one or more distributed computing resources, entities, logic entities, etc. In an exemplary embodiment, the network 1040 may connect the issuing bank system 1020 to the smart phone 1050. As used herein, the issuing bank system 1020 may be an entity that creates, manages, oversees, personalizes, and maintains information, including personal and/or confidential information, related to smart cards and users of smart cards. In an exemplary embodiment, the issuing bank system 1020 may also have the ability to create and store user information in a secure manner and to communicate with the smart card 1002 via the EMV transaction 1006 or the network 1040.

Among other processing capability, in an exemplary embodiment the issuing bank system 1020 may comprise a processor core 1022 having processing circuitry 1026, memory 1024 and logic 1028. The issuing bank system 1020 may also comprise a card management, authorization and fraud management module 1032, a biometric management module 1034, a trust establishment module 1036 and a digital banking system module 1038. In an exemplary embodiment, the card management, authorization and fraud management module 1032, the biometric management module 1034, the trust establishment module 1036 and the digital banking system module 1038 may comprise software and/or firmware configured to be executed by the processing core 1022 to perform certain functions as described herein. In some embodiments, some or all of the card management, authorization and fraud management module 1032, the biometric management module 1034, the trust establishment module 1036 and the digital banking system module 1038 may be located in the same location or may be located in separate locations.

In an exemplary embodiment, the smart phone 1050 may be in communication with the network 1040 over a communication interface 1041. In an exemplary embodiment, the communication interface 1041 may be any communication interface or network that provides wired or wireless connectivity between the smart phone 1050 and the network 1040. In an exemplary embodiment, the network 1040 may comprise wireless communication links, such as, for example, WiFi, Bluetooth, cellular, etc., and may comprise wired communication links, such as, for example, a LAN, a WAN, or other communication interface. In an exemplary embodiment, communication from the smart phone 1050 to the network 1040 and to the issuing bank system 1020 may occur over a communication link 1044 and may be referred to as “upstream” traffic; and communication from the issuing bank system 1020 and the network 1040 to the smart phone 1050 may occur over a communication link 1042 and may be referred to as “downstream” traffic. In an exemplary embodiment, the communication interface 1041 comprises both communication links 1042 and 1044. Further, while illustrated as single connections, the communication links 1042 and 1044 may comprise more than one connection and may comprise wired and/or wireless communication links. Exemplary embodiments of information that may be communicated over the communication links 1042 and 1044 include, voice, data, etc., and in some embodiments, include transaction information relating to interactive on-line trust establishment. In an exemplary embodiment, the smart card 1002 and the smart phone 1050 belong to the same user.

In an exemplary embodiment, the smart phone 1050 may comprise an application (app) 1052 provided by the issuing bank system 1020 or another provider and executable by the smart phone 1050 to allow the smart phone 1050 to interact with the issuing bank system 1020. The smart phone 1050 may also comprise a display 1054, such as a screen or a touch-sensitive screen. In an exemplary embodiment, messages from the issuing bank system 1020, such as the message 1058, may be displayed to a user of the smart phone 1050 via the app 1052. In an exemplary embodiment, the app 1052 may also provide the user a way to communicate with the issuing bank system 1020, such as, for example, buttons 1062 and 1064.

In an exemplary embodiment, one or more biometric templates are formed and expanded through a verified transactional enrollment process. A first biometric probe collected is an unverified biometric reference in the first biometric template as described above. New biometric templates are added if subsequent biometric probes do not yield a successful match against any of the existing biometric templates. Biometric templates are expanded through the verified transactional enrollment process as described above. Once sufficient biometric reference data is collected the enrollment process is complete.

In one exemplary embodiment of the example shown in FIG. 10, trust in the enrollment process is established by “out-of-band” interactions with the cardholder through the digital banking system 1038 and the mobile banking application 1052. In an exemplary embodiment, this interaction may be managed by the card management, authorization and fraud management module 1032 and digital banking system module 1038.

In another exemplary embodiment of the example shown in FIG. 10, trust in the enrollment process is established by “out-of-band” communications with the smart phone 1050. Such interactions may be considered “non-interactive” because the digital banking system 1038 and the mobile banking application 1052 may communicate with the smart phone 1050 to determine, for example, the location of the smart phone 1050, without user interaction.

In an exemplary embodiment, interactivity could take various forms. For example, a mobile app interaction per payment transaction may occur during a transactional enrollment window. As another example, a one-time mobile app interaction, for example, on completion of transactional enrollment may occur.

An example of on-line biometric and transaction processing may include the biometric management module 1034 extracting the status of on-card biometric verification and transactional enrollment processes from the smart card 1002 via the EMV transaction 1006.

In another exemplary embodiment, during and after enrollment, on-line payment authorization limits can be set appropriately based on trust establishment status (e.g., low value contactless during enrollment; high value contactless transactions allowed after enrollment).

As an example of mobile app interactivity-based trust establishment, during enrollment, push notifications can be issued by the issuing bank system 1020 to the smart phone 1050 to actively confirm genuine cardholder presence.

In an exemplary embodiment, after enrollment, push notifications can be sent to the user to confirm by user attestation that the cardholder has retained possession of the smart card 1002 during the enrollment period. User responses to push notifications can be used for on-line trust establishment.

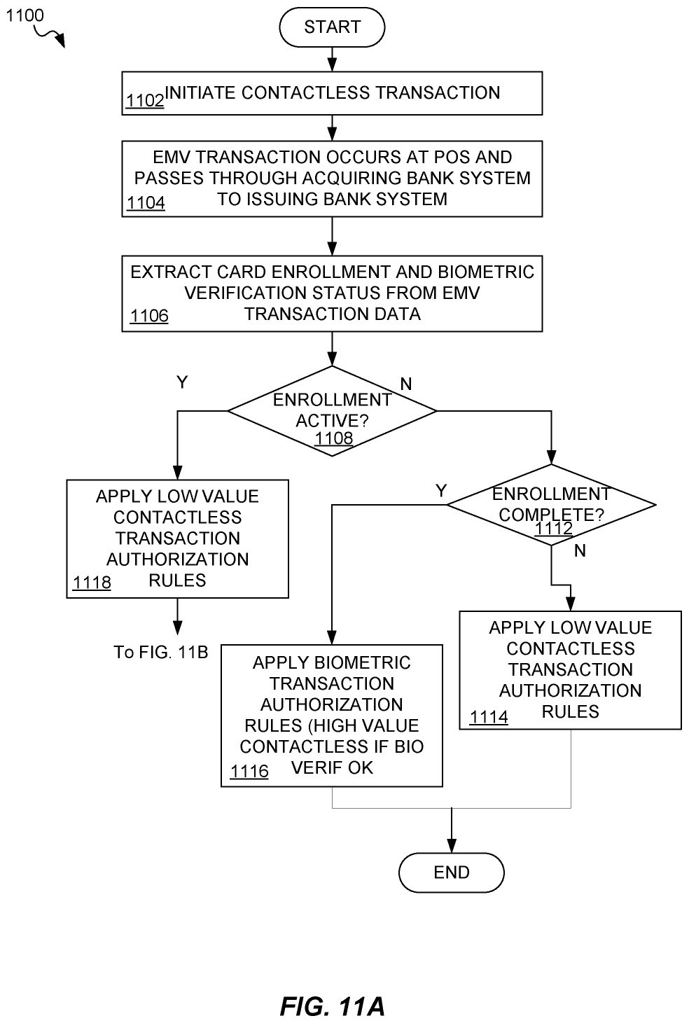

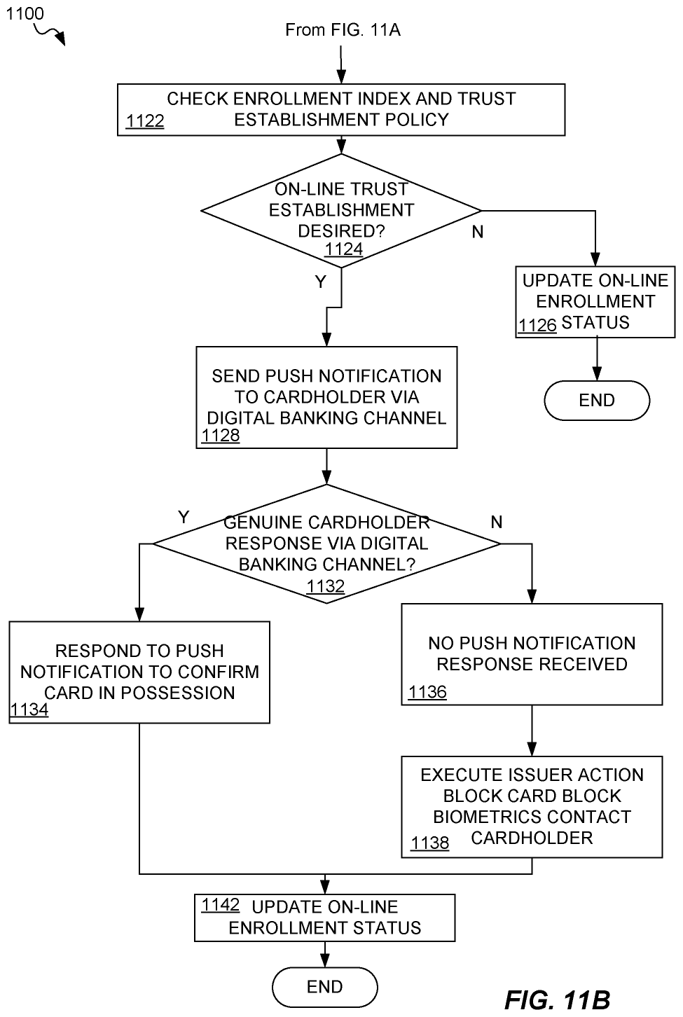

FIGS. 11A and 11B collectively are a flow chart showing an exemplary embodiment of a method for on-line verified transactional biometric enrollment with interactivity. The method 1100 describes an exemplary embodiment of transactional biometric enrollment with interactive on-line trust establishment. The blocks in the method 1100 can be performed in or out of the order shown and some blocks may be performed in parallel.

In block 1102 a contactless transaction is initiated. For example, a user may initiate a transaction at a POS terminal using a smart card during which a biometric sample may be captured.

In block 1104, an EMV transaction occurs and passes through an acquiring bank system to an issuing bank system. For example, the EMV transaction 1006 (FIG. 10) occurs at the POS terminal 1008. The transaction passes through the acquiring bank system 1012, the payment server 1014 and interacts with the issuing bank system 1020.

In block 1106 card enrollment information and biometric verification status are extracted by the issuing bank system 1020 via the EMV transaction. For example, the biometric management module 1034 and the trust establishment module 1036 in the issuing bank system 1020 may analyze the details of the EMV transaction 1006 and extract the card enrollment information and biometric verification status from the smart card 104. For example, the smart card 104 sends card enrollment and biometric verification status at the end of every payment transaction as part of the Issuer Application Data (IAD). The biometric management system 1034 stores this information for a number of transactions in a history. As a new payment transaction authorization is requested, the biometric management system 1034 checks the enrollment status of the user.

In block 1108 it is determined whether enrollment is active and in progress. If it is determined in block 1108 that enrollment is not active, then in block 1112 it is determined whether enrollment is complete. For example, the biometric management module 1034 and the trust establishment module 1036 may determine whether enrollment is active and whether enrollment is complete.

If it is determined in block 1108 that enrollment is active, then in block 1118 low value contactless transaction authorization rules are applied to the current transaction by the card management, authorization and fraud module 1032 in the issuing bank system 1020 and the process proceeds to block 1122.

If it is determined in block 1108 that enrollment is not active, then in block 1112 it is determined whether enrollment is complete.

If it is determined in block 1112 that enrollment is not complete, then in block 1114 low value contactless transaction authorization rules are applied to the current transaction by the card management, authorization and fraud module 1032 in the issuing bank system 1020 and the process ends.

If it is determined in block 1112 that enrollment is complete, then in block 1116 biometric transaction authorization rules are applied to the current transaction by the card management, authorization and fraud module 1032 in the issuing bank system 1020 and the process ends. For example, a high value contactless transaction may be authorized if the biometric verification on the current transaction is successful.

In block 1122, the biometric management module 1034 and the trust establishment module 1036 check the enrollment index and the trust establishment policy. For example, the biometric management system 1034 checks enrollment status and whether trust has to be established prior to starting a new template area.

In block 1124, it is determined whether on-line trust establishment is desired. For example, the biometric management module 1034 and the trust establishment module 1036 determine whether on-line trust establishment is desired. For example, the issuing bank system might decide to have a one-off trust establishment process at the end of enrollment (which may be performed early in the enrollment process) or on a regular basis.

If it is determined in block 1124 that on-line trust establishment is not desired, then in block 1126 the biometric management module 1034 and the trust establishment module 1036 update the user's enrollment status as described above and the process ends.

If it is determined in block 1124 that on-line trust establishment is desired, then in block 1128, the digital banking system 1038 in the issuing bank system 1020 sends a push notification via a digital banking channel to a user. For example, the digital banking system 1038 may send a push notification to the smart phone 1050 over communication link 1042 via the network 1040. The push notification may interact with the app 1052 on the smart phone 1050 to present the user with a message, such as the message 1058 to verify a transaction and thereby verify a biometric probe.

In block 1132, the digital banking system 1038 determines whether a user has responded to the push message sent in block 1128.

If it is determined in block 1132 that a user response was received, then in block 1134 the digital banking system 1038 determines that the smart card is in the possession of the user. For example, a user may respond to the message 1058 via communication link 1044 informing the digital banking system 1038 that the user is in possession of the card and the transaction is legitimate so that the card management, authorization and fraud management module 1032 can determine that the genuine card holder is in possession of the card and trust can be established. This response may be used to verify that a biometric probe captured during this transaction is a trusted biometric reference.

If it is determined in block 1132 that a user response was not received, then in block 1136 the digital banking system 1038 determines that the transaction may not be legitimate and in block 1138, the biometric management module 1034 and the card management, authorization and fraud management module 1032 take certain actions. For example, if there is no user response, or if the user responds to the push notification that they are not performing the transaction, a fraud management process may be initiated. For example, transactions may be blocked on the smart card or the ability to process biometric data may be suspended and the cardholder may be contacted. In some embodiments, if the card management, authorization and fraud management module 1032 does not receive a positive response it may increment a potential fraud detected counter (PFDC) and may block a compromised card once the PFDC exceeds a PFDC limit. The PFDC may be reset each time a successful online authorization is performed.

In block 1142, the user's on-line enrollment status is updated and the process ends.

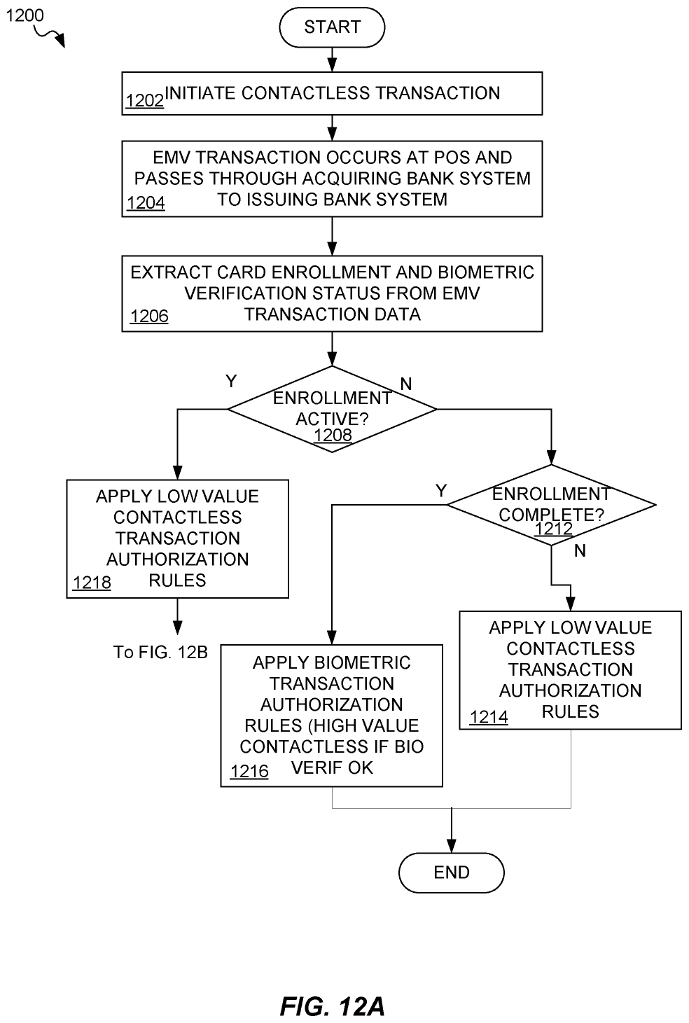

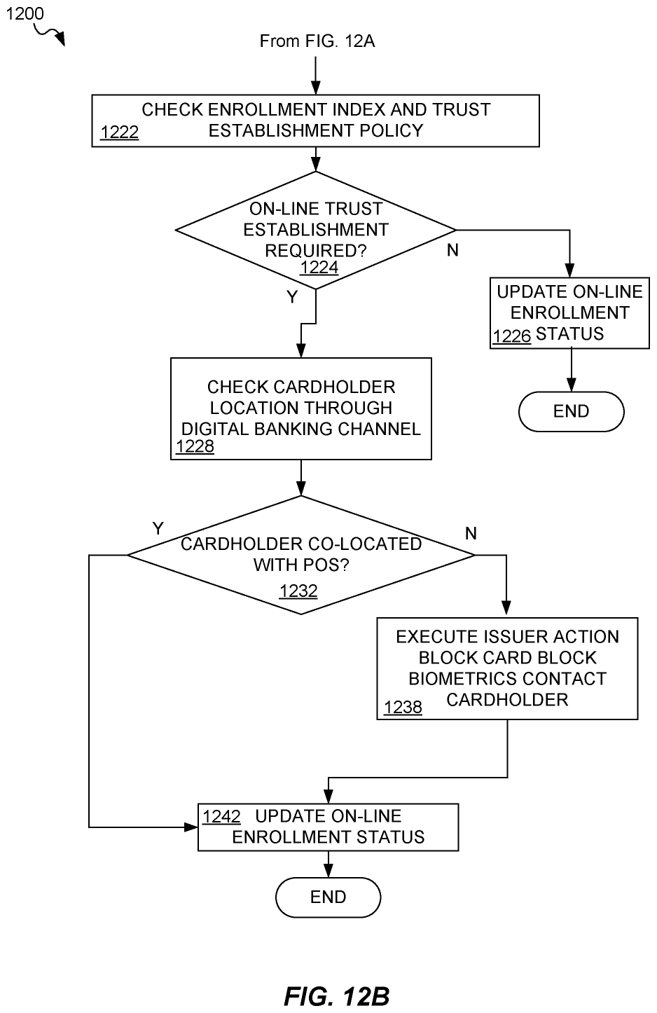

FIGS. 12A and 12B collectively are a flow chart showing a method for on-line verified transactional biometric enrollment without interactivity. The method 1200 describes an exemplary embodiment of transactional biometric enrollment with non-interactive on-line trust establishment. The blocks in the method 1200 can be performed in or out of the order shown and some blocks may be performed in parallel.

In block 1202 a contactless transaction is initiated. For example, a user may initiate a transaction at a POS terminal using a smart card during which a biometric sample may be captured.

In block 1204, an EMV transaction occurs and passes through an acquiring bank system to an issuing bank system. For example, the EMV transaction 1006 (FIG. 10) occurs at the POS terminal 1008. The transaction passes through the acquiring bank system 1012, the payment server 1014 and interacts with the issuing bank system 1020.

In block 1206 card enrollment information and biometric verification status are extracted from the EMV transaction. For example, the biometric management module 1034 and the trust establishment module 1036 in the issuing bank system 1020 may analyze the details of the EMV transaction 1006 and extract the card enrollment information and biometric verification status from the smart card 104. For example, the smart card 104 sends card enrollment and biometric verification status at the end of every payment transaction as part of the Issuer Application Data (IAD). The biometric management system 1034 stores this information for a number of transactions in a history. As a new payment transaction authorization is requested, the biometric management system 1034 checks the enrollment status of the user.

In block 1208 it is determined whether enrollment is active and in progress. If it is determined in block 1208 that enrollment is not active, then in block 1212 it is determined whether enrollment is complete. For example, the biometric management module 1034 and the trust establishment module 1036 may determine whether enrollment is active and whether enrollment is complete.

If it is determined in block 1208 that enrollment is active, then in block 1218 low value contactless transaction authorization rules are applied to the current transaction by the card management, authorization and fraud module 1032 in the issuing bank system 1020 and the process proceeds to block 1222.

If it is determined in block 1212 that enrollment is not complete, then in block 1214 low value contactless transaction authorization rules are applied to the current transaction by the card management, authorization and fraud module 1032 in the issuing bank system 1020 and the process ends.

If it is determined in block 1212 that enrollment is complete, then in block 1216 biometric transaction authorization rules are applied to the current transaction by the card management, authorization and fraud module 1032 in the issuing bank system 1020 and the process ends. For example, a high value contactless transaction may be authorized if the biometric verification on the current transaction is successful.

In block 1222, the biometric management module 1034 and the trust establishment module 1036 check the enrollment index and the trust establishment policy. For example, the biometric management system 1034 checks enrollment status and whether trust has to be established prior to starting a new template area.

In block 1224, it is determined whether on-line trust establishment is desired. For example, the biometric management module 1034 and the trust establishment module 1036 determine whether on-line trust establishment is desired. For example, the issuing bank system might decide to have a one-off trust establishment process at the end of enrollment (which may be performed early in the enrollment process) or on a regular basis.

If it is determined in block 1224 that on-line trust establishment is not desired, then in block 1226 the biometric management module 1034 and the trust establishment module 1036 update the user's enrollment status as described above and the process ends.

If it is determined in block 1224 that on-line trust establishment is desired, then in block 1228, the digital banking system 1038 in the issuing bank system 1020 attempts to determine the location of the card holder. For example, the GPS location of the smart phone 1050 may be determined in real time and the information provided to the digital banking system 1038 in the issuing bank system 1020 via the network 1040 and communication links 1042 and 1044. If the smart phone 1050 and the smart card 104 are in the same location, the transaction may be approved and trust may be established.

In block 1232, using the location of the smart phone 1050, the digital banking system 1038 determines whether the smart phone 1050 (and by extension, the card holder) is co-located with the POS terminal 1008. For example, if the card management, authorization and fraud management module 1032 does not receive a positive response it may increment a potential fraud detected counter (PFDC) and may block a compromised card once the PFDC exceeds a PFDC limit. The PFDC may be reset each time a successful online authorization is performed.

If it is determined in block 1232 that the smart phone 1050 (and by extension, the card holder) is co-located with the POS terminal 1008, the transaction proceeds and in block 1242, the user's enrollment status is updated as described above and the process ends. This response may be used to verify that a biometric probe captured during this transaction is a verified biometric reference.

If it is determined in block 1232 that the smart phone 1050 (and by extension, the card holder) is not co-located with the POS terminal 1008, then in block 1238, the digital banking system 1038 determines that the transaction may not be legitimate and the biometric management module 1034 and the card management, authorization and fraud management module 1032 take certain actions. For example, transactions may be blocked on the smart card, the ability to process biometric data may be suspended and the cardholder may be contacted.

In block 1242, the user's enrollment status is updated as described above and the process ends.

Implementation examples are described in the following numbered clauses:
1. A method for generating a trusted biometric reference, comprising initiating a first contactless transaction; capturing a first biometric sample during the first contactless transaction; generating a first biometric probe from the first biometric sample; initiating a contact fallback event; entering a secondary identifier; if the secondary identifier confirms an authorized user, generating a first trusted biometric reference from the first biometric probe; and storing the first trusted biometric reference in a biometric template seed.
2. The method of clause 1, wherein the secondary identifier is a personal identification number (PIN) entered during the contact fallback event.
3. The method of clause 1, wherein the secondary identifier is a payment services directive 2 (PSD2) transaction initiated by a smart card issuing authority.
4. The method of any of clauses 1 through 3, further comprising comparing a subsequent biometric claim against the biometric template seed to determine whether the subsequent biometric claim is a verified biometric reference.
5. A method for transactional biometric enrollment, comprising building a biometric template seed comprising a plurality of trusted biometric references; initiating a first contactless transaction; capturing a first biometric sample during the first contactless transaction; determining a biometric enrollment status of a user; if the enrollment status is active, determining if a biometric template seed is complete; and if the biometric template seed is complete, generating a first biometric probe from the first biometric sample, comparing the first biometric probe to the biometric template seed and if the first biometric probe matches the biometric template seed, generating a first verified biometric reference from the first biometric probe and expanding a first biometric template with the first verified biometric reference.
6. The method of clause 5, further comprising capturing a subsequent biometric sample during a subsequent contactless transaction; generating a subsequent biometric probe from the subsequent biometric sample; comparing the subsequent biometric probe to the biometric template seed and to any preceding verified biometric reference and if the subsequent biometric probe matches one of the biometric template seed and any preceding verified biometric reference, generating a subsequent verified biometric reference from the subsequent biometric probe and expanding the first biometric template with the subsequent verified biometric reference.
7. A method for transactional biometric enrollment, comprising initiating a first contactless transaction; capturing a first biometric sample during the first contactless transaction; determining a biometric enrollment status of a user; if the enrollment status is active, generating a first biometric probe from the first biometric sample and storing the first biometric probe as a biometric reference in a first biometric template; capturing a first subsequent biometric sample during a first subsequent contactless transaction; determining the biometric enrollment status of the user; if the enrollment status is active, generating a first subsequent biometric probe from the first subsequent biometric sample; and comparing the first subsequent biometric probe to the first biometric template and if the first subsequent biometric probe does not match the first biometric template, generating a second biometric template in which to store the first subsequent biometric probe as a first unverified biometric reference.
8. The method of clause 7, further comprising capturing a second subsequent biometric sample during a second subsequent contactless transaction; generating a second subsequent biometric probe from the second subsequent biometric sample; and comparing the second subsequent biometric probe to the first biometric template and to the second biometric template and if the second subsequent biometric probe matches one of the first biometric template and the second biometric template, generating a second subsequent verified biometric reference from the second subsequent biometric probe and storing the second subsequent verified biometric reference in one of the first biometric template and the second biometric template.
9. The method of clause 8, further comprising capturing a further subsequent biometric sample during a further subsequent contactless transaction; generating a further subsequent biometric probe from the further subsequent biometric sample; comparing the further subsequent biometric probe to the first biometric template and to the second biometric template and if the further subsequent biometric probe matches both the first biometric template and the second biometric template, generating a further subsequent verified biometric reference from the further subsequent biometric probe and generating a third biometric template that includes the first biometric template and the second biometric template.
10. The method of any of clauses 7 through 9, wherein a trust event extends trust to the first unverified biometric reference that was used to form the second biometric template.
11. The method of any of clauses 7 through 10, wherein the first biometric template and the second biometric template are deleted.
12. A method for transactional biometric enrollment, comprising initiating a first contactless transaction; capturing a first biometric sample during the first contactless transaction; generating a first biometric probe from the first biometric sample; determining a biometric enrollment status of a user; if the enrollment status is active, determining whether on-line trust establishment is desired; if on-line trust establishment is desired, communicating a request to a user device; and in response to affirmation of the request, saving the first biometric probe as a trusted biometric reference in a biometric template.
13. The method of clause 12, wherein the request is a push notification to the user.
14. The method of clause 12, wherein the request is a query for a device location.
15. A system for generating a trusted biometric reference, comprising a biometric sensor configured to capture a first biometric sample during a first contactless transaction; a processor and biometric processing logic configured to generate a first biometric probe from the first biometric sample; a secondary identifier entered during a contact fallback event; if the secondary identifier confirms an authorized user, the processor and biometric processing logic configured to generate a first trusted biometric reference from the first biometric probe; and a memory configured to store the first trusted biometric reference in a biometric template seed.
16. The system of clause 15, wherein the secondary identifier is a personal identification number (PIN) entered during the contact fallback event.
17. The system of clause 15, wherein the secondary identifier is a payment services directive 2 (PSD2) transaction initiated by a smart card issuing authority.
18. The system of any of clauses 15 through 17, further comprising a matcher configured to compare a subsequent biometric claim against the biometric template seed to determine whether the subsequent biometric claim is a verified biometric reference.
19. A system for transactional biometric enrollment, comprising a biometric template seed comprising a plurality of trusted biometric references; a biometric sensor configured to capture a first biometric sample during a first contactless transaction; a biometric processing logic configured to determine a biometric enrollment status of a user; if the enrollment status is active, the biometric processing logic configured to determine if a biometric template seed is complete; if the biometric template seed is complete, a processor and the biometric processing logic configured to generate a first biometric probe from the first biometric sample; and a matcher configured to compare the first biometric probe to the biometric template seed and if the first biometric probe matches the biometric template seed, the processor and biometric processing logic configured to generate a first verified biometric reference from the first biometric probe and a memory configured to store the first verified biometric reference in a first biometric template.
20. The system of clause 19, further comprising the biometric sensor configured to capture a subsequent biometric sample during a subsequent contactless transaction; the processor and the biometric processing logic configured to generate a subsequent biometric probe from the subsequent biometric sample; the matcher configured to compare the subsequent biometric probe to the biometric template seed and to any preceding verified biometric reference and if the subsequent biometric probe matches one of the biometric template seed and any preceding verified biometric reference, the processor and biometric processing logic configured to generate a subsequent verified biometric reference from the subsequent biometric probe, the memory configured to store the subsequent verified reference in the first biometric template.
21. A system for transactional biometric enrollment, comprising a biometric sensor configured to capture a first biometric sample during a first contactless transaction; a biometric processing logic configured to determine a biometric enrollment status of a user; if the enrollment status is active, a processor and the biometric processing logic configured to generate a first biometric probe from the first biometric sample; a memory configured to store the first biometric probe as a biometric reference in a first biometric template; the biometric sensor configured to capture a first subsequent biometric sample during a first subsequent contactless transaction; a biometric processing logic configured to determine a biometric enrollment status of a user; if the enrollment status is active, the processor and the biometric processing logic configured to generate a first subsequent biometric probe from the first subsequent biometric sample; and a matcher configured to compare the first subsequent biometric probe to the first biometric template and if the first subsequent biometric probe does not match the first biometric template, the processor and biometric processing logic configured to generate a second biometric template in which to store the first subsequent biometric probe as an unverified biometric reference.
22. The system of clause 21, further comprising the biometric sensor configured to capture a second subsequent biometric sample during a second subsequent contactless transaction; the processor and biometric processing logic configured to generate a second subsequent biometric probe from the second subsequent biometric sample; the matcher configured to compare the second subsequent biometric probe to the first biometric template and to the second biometric template and if the second subsequent biometric probe matches one of the first biometric template and the second biometric template, the processor and biometric processing logic configured to generate a second subsequent verified biometric reference from the second subsequent biometric probe, the memory configured to store the second subsequent verified biometric reference in one of the first biometric template and the second biometric template.
23. The system of clause 22, further comprising the processor and biometric processing logic configured to capture a further subsequent biometric sample during a further subsequent contactless transaction; the processor and biometric processing logic configured to generate a further subsequent biometric probe from the further subsequent biometric sample; the matcher configured to compare the further subsequent biometric probe to the first biometric template and to the second biometric template and if the further subsequent biometric probe matches both the first biometric template and the second biometric template, the processor and biometric processing logic configured to generate a further subsequent verified biometric reference from the further subsequent biometric probe and generating a third biometric template that includes the first biometric template and the second biometric template.
24. The system of any of clauses 21 through 23, wherein a trust event extends trust to the first unverified biometric reference that was used to form the second biometric template
25. The system of any of clauses 21 through 24, wherein the first biometric template and the second biometric template are deleted.
26. A system for transactional biometric enrollment, comprising: a biometric sensor configured to capture a first biometric sample during the first contactless transaction; a processor and biometric processing logic configured to generate a first biometric probe from the first biometric sample; the biometric processing logic configured to determine a biometric enrollment status of a user; if the enrollment status is active, a biometric management module and a trust establishment module configured to determine whether on-line trust establishment is desired; if on-line trust establishment is desired, a digital banking system configured to communicate a request to a user device; and in response to affirmation of the request, saving the first biometric probe as a trusted biometric reference in a biometric template.
27. The system of clause 26, wherein the request is a push notification to the user.
28. The system of clause 26, wherein the request is a query for a device location.

One or more illustrative or exemplary embodiments of the invention have been described above. However, it is to be understood that the invention is defined by the appended claims and is not limited to the specific embodiments described.

What is claimed is:

1. A method for generating a trusted biometric reference, comprising:
initiating a first contactless transaction;
capturing a first biometric sample during the first contactless transaction;
generating a first biometric probe from the first biometric sample;
initiating a contact fallback event;
entering a secondary identifier;
if the secondary identifier confirms an authorized user, generating a first trusted biometric reference from the first biometric probe; and
storing the first trusted biometric reference in a biometric template seed.

2. The method of claim 1, wherein the secondary identifier is a personal identification number (PIN) entered during the contact fallback event.

3. The method of claim 1, wherein the secondary identifier is a payment services directive 2 (PSD2) transaction initiated by a smart card issuing authority.

4. The method of claim 1, further comprising comparing a subsequent biometric claim against the biometric template seed to determine whether the subsequent biometric claim is a verified biometric reference.

5. A method for transactional biometric enrollment, comprising:
building a biometric template seed comprising a plurality of trusted biometric references;
initiating a first contactless transaction;
capturing a first biometric sample during the first contactless transaction;
determining a biometric enrollment status of a user;
if the enrollment status is active, determining if a biometric template seed is complete; and
if the biometric template seed is complete, generating a first biometric probe from the first biometric sample, comparing the first biometric probe to the biometric template seed and if the first biometric probe matches the biometric template seed, generating a first verified biometric reference from the first biometric probe and expanding a first biometric template with the first verified biometric reference.

6. The method of claim 5, further comprising:
capturing a subsequent biometric sample during a subsequent contactless transaction;
generating a subsequent biometric probe from the subsequent biometric sample;
comparing the subsequent biometric probe to the biometric template seed and to any preceding verified biometric reference and if the subsequent biometric probe matches one of the biometric template seed and any preceding verified biometric reference, generating a subsequent verified biometric reference from the subsequent biometric probe and expanding the first biometric template with the subsequent verified biometric reference.

7. A method for transactional biometric enrollment, comprising:
initiating a first contactless transaction;
capturing a first biometric sample during the first contactless transaction;
determining a biometric enrollment status of a user;
if the enrollment status is active, generating a first biometric probe from the first biometric sample and storing the first biometric probe as a biometric reference in a first biometric template;
capturing a first subsequent biometric sample during a first subsequent contactless transaction;
determining the biometric enrollment status of the user;
if the enrollment status is active, generating a first subsequent biometric probe from the first subsequent biometric sample; and
comparing the first subsequent biometric probe to the first biometric template and if the first subsequent biometric probe does not match the first biometric template, generating a second biometric template in which to store the first subsequent biometric probe as a first unverified biometric reference.

8. The method of claim 7, further comprising:
capturing a second subsequent biometric sample during a second subsequent contactless transaction;
generating a second subsequent biometric probe from the second subsequent biometric sample; and
comparing the second subsequent biometric probe to the first biometric template and to the second biometric template and if the second subsequent biometric probe matches one of the first biometric template and the second biometric template, generating a second subsequent verified biometric reference from the second subsequent biometric probe and storing the second subsequent verified biometric reference in one of the first biometric template and the second biometric template.

9. The method of claim 8, further comprising:
capturing a further subsequent biometric sample during a further subsequent contactless transaction;
generating a further subsequent biometric probe from the further subsequent biometric sample; and
comparing the further subsequent biometric probe to the first biometric template and to the second biometric template and if the further subsequent biometric probe matches both the first biometric template and the second biometric template, generating a further subsequent verified biometric reference from the further subsequent biometric probe and generating a third biometric template that includes the first biometric template and the second biometric template.

10. The method of claim 8, wherein a trust event extends trust to the first unverified biometric reference that was used to form the second biometric template.

11. The method of claim 9, wherein the first biometric template and the second biometric template are deleted.

12. A method for transactional biometric enrollment, comprising:
initiating a first contactless transaction;
capturing a first biometric sample during the first contactless transaction;
generating a first biometric probe from the first biometric sample;
determining a biometric enrollment status of a user;
if the enrollment status is active, determining whether on-line trust establishment is desired;
if on-line trust establishment is desired, communicating a request to a user device; and
in response to affirmation of the request, saving the first biometric probe as a trusted biometric reference in a biometric template.

13. The method of claim 12, wherein the request is a push notification to the user.

14. The method of claim 12, wherein the request is a query for a device location.

15. A system for generating a trusted biometric reference, comprising:
a biometric sensor configured to capture a first biometric sample during a first contactless transaction;
a processor and biometric processing logic configured to generate a first biometric probe from the first biometric sample;
a secondary identifier entered during a contact fallback event;
if the secondary identifier confirms an authorized user, the processor and biometric processing logic configured to generate a first trusted biometric reference from the first biometric probe; and
a memory configured to store the first trusted biometric reference in a biometric template seed.

16. The system of claim 15, wherein the secondary identifier is a personal identification number (PIN) entered during the contact fallback event.

17. The system of claim 15, wherein the secondary identifier is a payment services directive 2 (PSD2) transaction initiated by a smart card issuing authority.

18. The system of claim 15, further comprising a matcher configured to compare a subsequent biometric claim against the biometric template seed to determine whether the subsequent biometric claim is a verified biometric reference.

19. A system for transactional biometric enrollment, comprising:
a biometric template seed comprising a plurality of trusted biometric references;
a biometric sensor configured to capture a first biometric sample during a first contactless transaction;
a biometric processing logic configured to determine a biometric enrollment status of a user;
if the enrollment status is active, the biometric processing logic configured to determine if a biometric template seed is complete;
if the biometric template seed is complete, a processor and the biometric processing logic configured to generate a first biometric probe from the first biometric sample; and
a matcher configured to compare the first biometric probe to the biometric template seed and if the first biometric probe matches the biometric template seed, the processor and biometric processing logic configured to generate a first verified biometric reference from the first biometric probe and a memory configured to store the first verified biometric reference in a first biometric template.

20. The system of claim 19, further comprising:
the biometric sensor configured to capture a subsequent biometric sample during a subsequent contactless transaction;
the processor and the biometric processing logic configured to generate a subsequent biometric probe from the subsequent biometric sample;
a matcher configured to compare the subsequent biometric probe to the biometric template seed and to any preceding verified biometric reference and if the subsequent biometric probe matches one of the biometric template seed and any preceding verified biometric reference, the processor and biometric processing logic configured to generate a subsequent verified biometric reference from the subsequent biometric probe, the memory configured to store the subsequent verified reference in the first biometric template.

21. A system for transactional biometric enrollment, comprising:
a biometric sensor configured to capture a first biometric sample during a first contactless transaction;
a biometric processing logic configured to determine a biometric enrollment status of a user;
if the enrollment status is active, a processor and the biometric processing logic configured to generate a first biometric probe from the first biometric sample;
a memory configured to store the first biometric probe as a biometric reference in a first biometric template;
the biometric sensor configured to capture a first subsequent biometric sample during a first subsequent contactless transaction;
a biometric processing logic configured to determine a biometric enrollment status of a user;
if the enrollment status is active, the processor and the biometric processing logic configured to generate a first subsequent biometric probe from the first subsequent biometric sample; and
a matcher configured to compare the first subsequent biometric probe to the first biometric template and if the first subsequent biometric probe does not match the first biometric template, the processor and biometric processing logic configured to generate a second biometric template in which to store the first subsequent biometric probe as an unverified biometric reference.

22. The system of claim 21, further comprising:
the biometric sensor configured to capture a second subsequent biometric sample during a second subsequent contactless transaction;
the processor and biometric processing logic configured to generate a second subsequent biometric probe from the second subsequent biometric sample;
the matcher configured to compare the second subsequent biometric probe to the first biometric template and to the second biometric template and if the second subsequent biometric probe matches one of the first biometric template and the second biometric template, the processor and biometric processing logic configured to generate a second subsequent verified biometric reference from the second subsequent biometric probe, the memory configured to store the second subsequent verified biometric reference in one of the first biometric template and the second biometric template.

23. The system of claim 22, further comprising:
the processor and biometric processing logic configured to capture a further subsequent biometric sample during a further subsequent contactless transaction;
the processor and biometric processing logic configured to generate a further subsequent biometric probe from the further subsequent biometric sample;
the matcher configured to compare the further subsequent biometric probe to the first biometric template and to the second biometric template and if the further subsequent biometric probe matches both the first biometric template and the second biometric template, the processor and biometric processing logic configured to generate a further subsequent verified biometric reference from the further subsequent biometric probe and generating a third biometric template that includes the first biometric template and the second biometric template.

24. The system of claim 22, wherein a trust event extends trust to the first unverified biometric reference that was used to form the second biometric template

25. The system of claim 23, wherein the first biometric template and the second biometric template are deleted.

26. A system for transactional biometric enrollment, comprising:
a biometric sensor configured to capture a first biometric sample during the first contactless transaction;
a processor and biometric processing logic configured to generate a first biometric probe from the first biometric sample;
the biometric processing logic configured to determine a biometric enrollment status of a user;
if the enrollment status is active, a biometric management module and a trust establishment module configured to determine whether on-line trust establishment is desired;
if on-line trust establishment is desired, a digital banking system configured to communicate a request to a user device; and
in response to affirmation of the request, saving the first biometric probe as a trusted biometric reference in a biometric template.

27. The system of claim 26, wherein the request is a push notification to the user.

28. The system of claim 26, wherein the request is a query for a device location.
